(19) United States
(12) Patent Application Publication
(10) Pub. No.: US 2014/0108971 A1
(43) Pub. Date: Apr. 17, 2014

(54) APPLICATION BUILDER

(71) Applicant: SALESFORCE.COM.INC., San Francisco, CA (US)

(72) Inventors: Jamie J. No, Bothell, WA (US); Vamsi Deepak Gadey, Fremont, CA (US); Beril Guvendik Maples, Oakland, CA (US)

(73) Assignee: SALESFORCE.COM.INC., San Francisco, CA (US)

(21) Appl. No.: 14/016,999

(22) Filed: Sep. 3, 2013

Related U.S. Application Data
(60) Provisional application No. 61/695,980, filed on Aug. 31, 2012.

(51) Int. Cl. G06F 3/0482

(52) U.S. Cl. CPC G06F 3/0482
USPC 715/762

(57) ABSTRACT

A method and system in which a host system sends to a user system, information which when consumed by the user system, causes a page to be displayed on the user system having features to place in an application for the user to choose from. In response, the host system receives from the user system, a selection of at least one feature to place in the application. The host system, generates the application based on the selection of the feature that was chosen. The application is then sent from the host system to the user system for use on the user system.

### CLAIM OF PRIORITY

This application claims the benefit of U.S. Provisional Patent Application 61/695,980 (Docket #988PROV) entitled TAB VISION, by Jamie No, filed Aug. 31, 2012 (Attorney Docket No. 988PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS REFERENCE TO RELATED APPLICATIONS

The following commonly owned, co-pending United States patents and patent applications, including the present application, are related to each other. Each of the other patents/applications are incorporated by reference herein in its entirety:

U.S. patent application Ser. No. 10/______, entitled APPLICATION BUILDER, by Jamie J. No et al., filed ______, 20______ (Attorney Docket No. 48-0C/988US).

### FIELD OF THE INVENTION

The field of the invention relates generally to the applications, such as applications for mobile device.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In conventional database systems, users access their data resources in one logical database. A user of such a conventional system typically retrieves data from and stores data on the system using the user's own systems. A user system might remotely access one of a plurality of server systems that might in turn access the database system. Data retrieval from the system might include the issuance of a query from the user system to the database system. The database system might process the request for information received in the query and send to the user system information relevant to the request. The ease of use and efficient retrieval of accurate information and subsequent delivery of this information to the user system, in a manner that is easy to understand, has been and continues to be a goal of administrators of database systems.

It also may be desirable to access servers by mobile devices. To access a server efficiently for a particular purpose it may be desirable to have an application tailored for that purpose and/or server.

Unfortunately, conventional database approaches might become inefficient, if for example, if the relationship is relatively complex. A database system may also process a query relatively slowly if, for example, a relatively large number of users substantially concurrently access the database system. Also, writing an applications can be tedious and may require extensive programming knowledge.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a block diagram of an example of an environment in which a system to create applications might be used.

FIG. 2 illustrates a block diagram of an embodiment of a server system including an application builder system.

FIG. 3 illustrates a flowchart of an embodiment of a server-side method of generating an application.

FIG. 4 illustrates a flowchart of an embodiment of a client-side method for initiating the application generation process on a user device.

FIG. 5 illustrates a flowchart of an embodiment of a server-side method for generating an application.

FIG. 6 illustrates a flowchart of an embodiment of a server-side method for providing application customization.

FIG. 7 illustrates a flowchart of an embodiment of a client-side method for customizing applications.

FIG. 8 shows a screenshot of an example a webpage of social network site having a link to the application builder.

FIG. 9 shows a screen shot of an embodiment of a page of a website for building applications.

FIG. 10 shows a screenshot of an embodiment of an interface for performing the first two steps of building an application.

FIG. 11 shows a screenshot of an example of an interface for providing the name of the application, choosing a template for the application and selecting whether to add an object.

FIG. 12 shows a screenshot of an example of an interface that includes a selection of objects to add to an application.

FIG. 13A shows a screenshot of an example interface of a overview page of a website for building applications.

FIG. 13B shows a screenshot of an embodiment of page for naming an application.

FIG. 13C shows a screenshot of an embodiment of page for adding a logo to an application.

FIG. 13D shows a screenshot of an embodiment of page for adding objects to an application.

FIG. 13E shows a screenshot of an embodiment of page for assigning the visibility of an application.

FIG. 13F shows a screenshot of an embodiment of page of applications.

FIG. 14 shows a screenshot of an example interface of a object page providing customization of an object imported or created.

FIG. 15 shows a screenshot of an example interface, within an object page, providing additional fields for further application customization.

FIG. 16 shows another screenshot of an example interface, within an object page, providing additional fields for further application customization.

FIG. 17 shows another screenshot of an example interface, within an object page, providing additional fields for further application customization.

FIG. 18 shows another screenshot of an example interface, within an object page, providing additional fields for further application customization.

FIG. 19 shows another screenshot of an example interface, within an object page, providing additional fields for further application customization.

FIG. 20 shows a screenshot of an example interface, within an object page, providing conditional formatting as a means of further application customization.

FIG. 21 shows another screenshot of an example interface, within an object page, providing conditional formatting as a means of further application customization.

FIG. 22 shows another screenshot of an example interface, within an object page, providing conditional formatting as a means of further application customization.

FIG. 23 shows another screenshot of an example interface, within an object page, providing conditional formatting as a means of further application customization.

FIG. 24 shows another screenshot of an example interface, within an object page, providing cross-object relationships to be utilized as a means of further application customization.

FIG. 25 shows another screenshot of an example interface, within an object page, providing cross-object relationships to be utilized as a means of further application customization.

FIG. 26 shows another screenshot of an example interface, within an object page, providing cross-object relationships to be utilized as a means of further application customization.

FIG. 27 shows another screenshot of an example interface, within an object page, providing cross-object relationships to be utilized as a means of further application customization.

FIG. 28 shows a screenshot of an example interface, within an object page, allowing actions to be created or added to an object as a means of further application customization.

FIG. 29 shows a screenshot of an example interface, within an object page, allowing action criteria to be determined.

FIG. 30 shows a screenshot of an example application preview page of website for building applications.

FIG. 31 shows a screenshot of an example component exchange, providing for component search and recommendation.

FIG. 32 shows another screenshot of an example component exchange, providing for component search and recommendation.

FIG. 33 shows a screenshot of an example interface providing an overview of installed components.

FIG. 34 shows a screenshot of an example interface providing an overview of installed components.

FIG. 35 shows a screenshot of an example interaction that allows for creation of a new page.

FIG. 36 shows a screenshot of an example interface, within a create new page box, providing options for template design and object import and/or creation.

FIG. 37 shows a screenshot of an example interface of a new blank page coupled to a page overview interface.

FIG. 38 shows a screenshot of an example interaction, within a create new application, providing for further customization.

FIG. 39 shows a screenshot of an example interface of a map coupled to a page overview interface.

FIG. 40 shows a screenshot of an example interface of a map preview webpage.

FIG. 41 illustrates a block diagram of an embodiment of a mobile device.

FIG. 42 illustrates a block diagram of an environment wherein an application generation system coupled to an on-demand database service might be used.

FIG. 43 shows a block diagram that further illustrates the elements of the application generation system coupled to an on-demand database service.

FIG. 44 shows a flowchart of an example of a method of using the environment of FIG. 43.

FIG. 45 is a method of making the environment of FIG. 42.

### DETAILED DESCRIPTION

General Overview

Systems and methods are provided for Application Builder.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, mechanisms and methods for providing Application Builder will be described with reference to example embodiments.

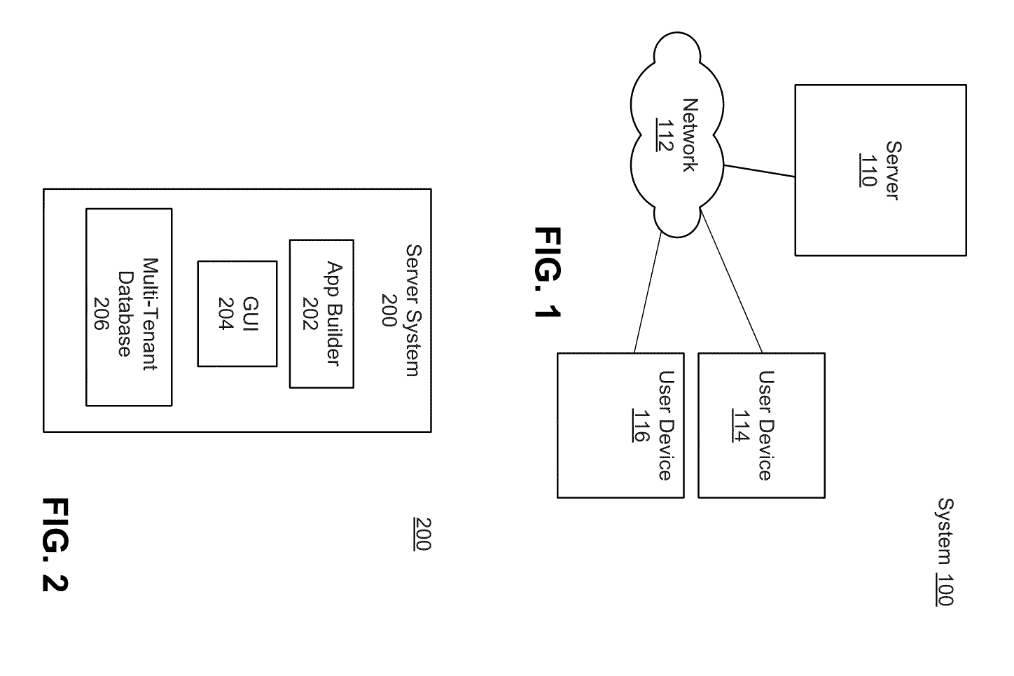

FIG. 1 shows a block diagram of an example of a system 100. System 100 includes server 110, network 112, user device 114, user device 116 and user device 116. In other embodiments, system 100 may not have all of the elements or features listed and/or may have other elements or features instead of, or in addition to, those listed.

System 100 provides tools via which a user may create an application. Application may be a collection of tabs, in which each tab provides access to an object. Packaging a particular group of objects together in an application and optionally setting up a workflow within the application may facilitate certain tasks. Server 110 stores code for creating an application for smart phone. Server 110 may be part of a multi-tenant database. Tenants of the multi-tenant database may access the code, via a user interface, and create an application. The application created may facilitate performing certain tasks on the multi-tenant database that the tenant may perform often. Alternatively, the application created may be made available to customers of the tenant for accessing the tenant's server and/or portions of the multi-tenant database set aside for the tenant.

Network 112 may be any combination of different type of communications networks. For example, network 112 may be any combination of Local Area Networks LANs), Wide Area Networks (WANs), wireless networks, and/or phone networks. Server 110 communicates, via network 112 with user devices.

User device 114 may be a system used by a user that has a permission level for making an application. For example, user device 114 may be a developer or administrator that works for or is associated with a tenant or the multi-tenant database. User device 114 may be any network device. A network device is any device that can connect to, and communicate via, a network. User device 114 may be a computer, laptop, smart phone, and/or tablet computer, for example. User device 114 may run a browser (an HTTP client) for communicating with server 110. The browser interprets rendering information from server 110, and displays an image specified by rendering information, in the display area browser. Alternatively, user device 114 may download an application from server 110 and communicate with server 110, via the application. Server 110 sends information to user device 114, which when interpreted or consumed by user device 114, determine which page of the application to display on the user device 114 and provides information, which is used for populating the page of the application being displayed. Whether a browser or an application is for accessing server 110, server 110 sends information, via network 112 to user device 114. User device 114 consumes the information sent, and then displays a page on the user device determined by the information sent.

User device 114 may be a system used by a user that accesses server 110. User device 114 may be any user device or network device. In at least one embodiment user device 116 is a smart phone. User device 116 may download an application created by user device 114 from server 110 or from a server of a tenant of the multi-tenant database system, and communicate with server 110, via the application. Server 110 sends information to user device 116, which when interpreted or consumed by user device 116, determine which page of the application to display on the user device 116 and provides information, which is used for populating the page of the application being displayed.

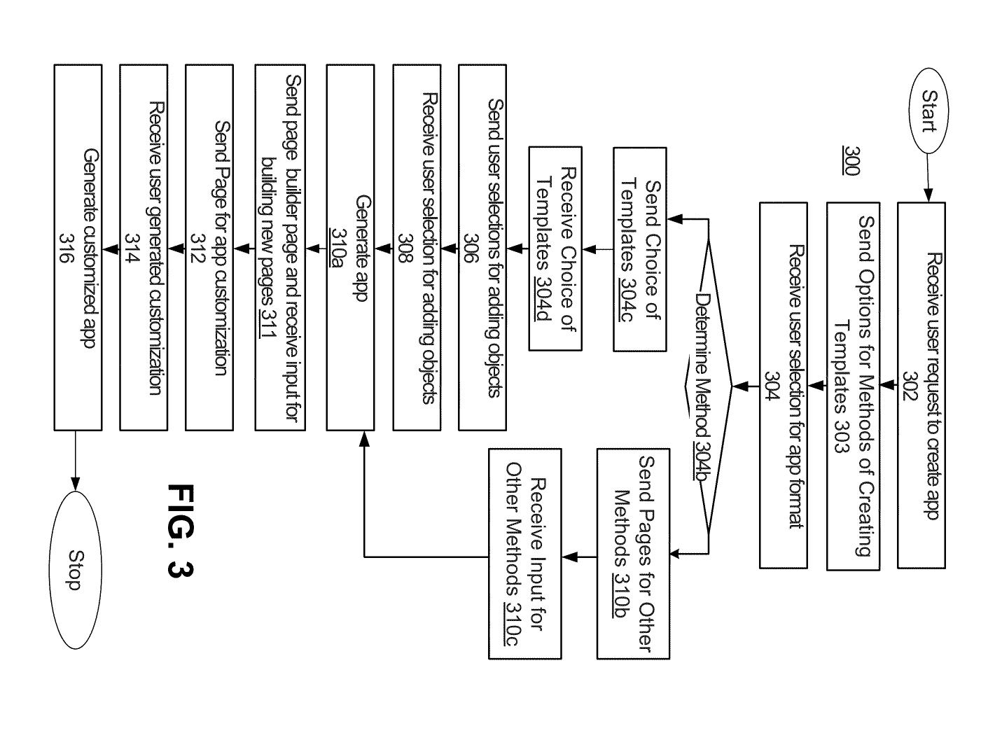

FIG. 2 shows a block diagram of an embodiment of the memory of server system 200. Server system 200 includes application builder 202, graphical user interface 204, and multi-tenant database 206. In other embodiments, server system 200 may not have all of the elements or features listed and/or may have other elements or features instead of, or in addition to, those listed.

Server system 200 may be an embodiment of server 100. Graphical User Interface (GUI) 204 includes code for producing rendering information or other information, which when consumed by user device 114 causes pages to appear on user device. the user interacts with the pages, and the interactions causes the messages to be sent to server system 204, directing server system to construct an application having the features chosen by the user. GUI 204 allows the user to interact with the server 110, via a network 112, by providing webpages to user systems having various fields and for users to fill in and various active icons that the user may interact with to request server 110 to perform various activities. Application builder 202 assimilates the data inputted by the user to the server, via GUI 204, and thereby creates the application. Multi-tenant database 206 provides a system in which various elements of hardware and software of the database system may be shared by one or more tenants. For example, the server 110 may interact with one or more customers simultaneously by providing access to application builder 202, via GUI 204.

In this specification, the term on-demand multi-tenant database system refers to a database in which portions of the database are rented to tenants. Each tenant may have their own officers, employees, and customers, whom have a level of access to the multi-tenant database as a result of the portion of the multi-tenant database that the tenant has access to as a result of being a tenant of the multi-tenant database. Multi-tenant database may have administrators that oversee the entire multi-tenant database. Additionally, each tenant may assign various employees or officers the role of administrator to oversee the portions of the database to which the tenant has access.

The term on-demand means that the database is provided to the tenant as a service. Beyond learning the various features of the GUI provided by the multi-tenant database, the tenant does not need to know how the multi-tenant database works and does not need to maintain the multi-tenant database. In an embodiment, the on-demand multi-tenant database is a relational database including schema having many database tables that are related to one another. In this specification that database tables may be referred to as database objects or as just simply tables or objects. The programming objects of the application created by application builder 202 may include one or more application pages of the application, and may retrieve data from the database objects of the multi-tenant database (e.g., by causing database commands to be executed). One or more of the programming objects of the application created may be interfaces for specific database objects of the multi-tenant database system.

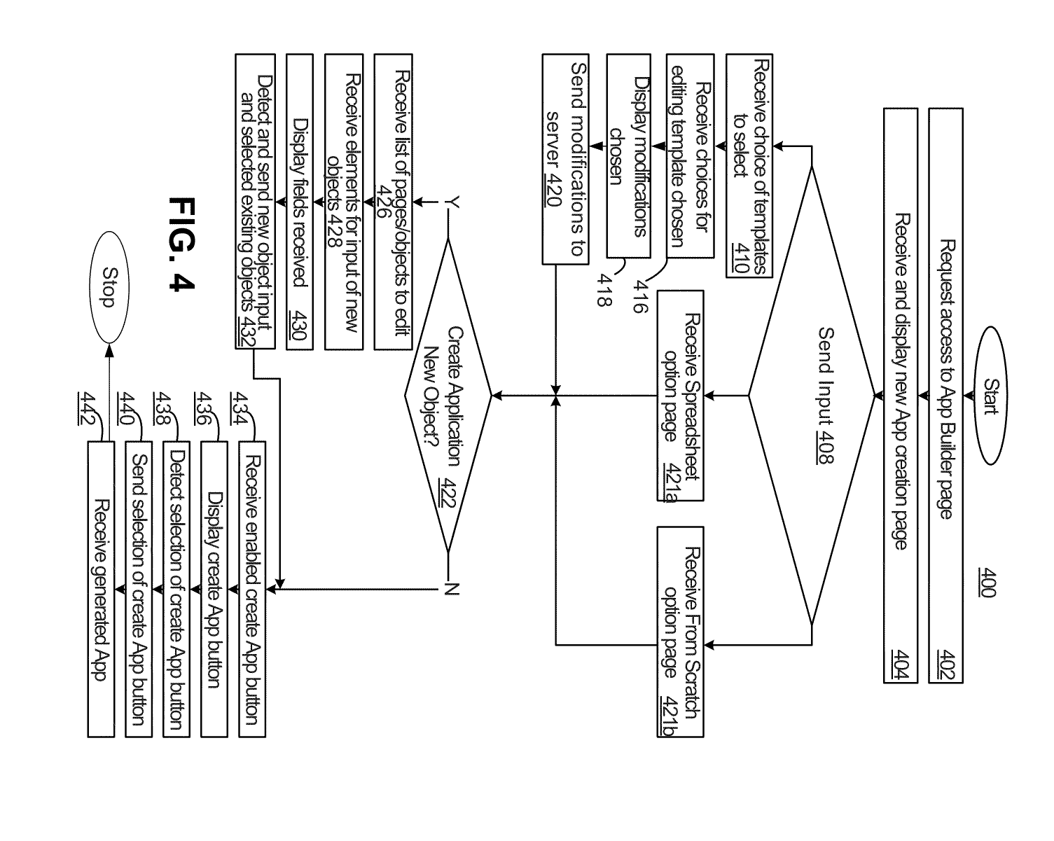

FIG. 3 shows a flowchart illustrating an embodiment of a method 300 for building an application from the server's point of view. In step 302, the server 110 receives the user's request to create an application. Step 302 may result from the user selecting a link in a social network page. The link may be next to the name of another user that created an application. For example, a first user may go to the social network and search for users that have created applications (e.g., to get advice on how to create an application). The first user may discover a second user that has posted an application for others to use, and in the post there may be a link for opening the newly created application. Next to the link for opening the newly created application, there may be a link for creating a new application. The first user may then select the link for creating a new application (where the link selected is associated with the post of the second user), and the selection of the link causes a request to be sent to the server 110 to initiate the programs for creating applications. Alternatively, step 302 may result from the user finding the a link to start the application in a menu of available programs on server 110. In step 303, in response to the request, server 110 sends a webpage for building an application. The webpage may include a field for associating a name with the application and choice of methods for creating the application. For example, the user may be able to choose between using a template of an application to create an application, creating an application using other methods, such as creating an application using a spreadsheet and creating an application from scratch. In step 304a, server 110 receives the user's selection and preferences for a method of creating an application.

In step 304b, the server 110 determines the method selected based on the selection received in step 304a. If it is determined in step 304b, that in step 304a, the user decided to use a template to create the application, then in step 304c, server 110 sends the user a choice of templates to choose from. In step 304d, the server receives the user's choice of templates. In step 306, server 110 sends the user one or more webpages with choices related to objects that the user can add to the application. For example, the user may be sent a choice of whether the to create a new object or to add an object that already exists. If the user selects to add an object that already exists, the use may be offered a choice of objects to select from. In step 308, the server 110 receives the user selections for adding one or more objects to the application. In step 310, the server 110 receives a request to generate an application and generates the application. In an embodiment, on each webpage sent to the user has a link (e.g., a button), which if selected by the user causes the application to be created. If the user selects link for creating an application after just assigning a name to the application, without having performed any other steps, then an application is created having nothing more than a name, but the application does not do anything. If the user selects the link for creating an application after selecting a template, but not doing anything else the application will be essentially no different than the template.

Returning to step 304b, if it is determined that the user selected another method (other than selecting a template), then in step 310b, webpages are sent to the user for creating the application via the other method selected. In step 310c, the server 110 receives the pages, objects, and application created by the user. There may be multiple exchanges between the user device and server as the user uploads portions of the application. After step 310c, method 300 proceeds to step 310a.

After step 310a, in step 311, the server 110 sends the a webpage for building pages of the application. The pages may be part of one or more particular objects. Also, in step 311, server 110 receives input from the user for building pages, which may start a new page or revise (e.g., change, add, or remove a feature) an existing page. In step 311, the user may change a page and then receives a new page for building pages that reflects the change made. Step 311 may involve several instances of the user uploading a revision to one or more application pages, and the server returning a webpage reflecting the revisions uploaded by the user. In step 312, the server 110 enables application customization. For example, server 110 sends one or more webpages to the user that have options for the user to select to customize the application by editing (e.g., changing adding, and/or deleting) the objects, fields, and/or pages of the application. In step 314, the server 110 receives the user-generated customization. In step 316, the server 110 generates the customized application. Steps 312, 314, and 316 may be repeated multiple times to further customize the application.

In at least one embodiment, each of the steps of method 300 is a distinct step. In another embodiment, although depicted as distinct steps in FIG. 3, step 302-316 may not be distinct steps. In other embodiments, method 300 may not have all of the above steps and/or may have other steps in addition to or instead of those listed above. The steps of method 300 may be performed in another order. Subsets of the steps listed above as part of method 300 may be used to form their own method.

FIG. 4 shows a flowchart of an embodiment of method 400 for building an application from the user device's point of view. In step 402, the user first requests access to a page for building an application, which may be referred to as an Application Builder page. In step 404, the user receives an application creation page. The received application creation page is displayed on user device 114, which offers the user a choice of methods of making the application. In step 408, the user device sends data to the server for selecting user format preferences. For example, the user device 114 sends a choice of whether to use a template of an application to create an application, whether to create an application with a spreadsheet, whether to create an application from scratch, or whether to use another method of creating an application. The selection chosen in step 408 determines the next step in method 400.

If the user device sent a selection of a template, then method 400 proceeds to step 410. In step 410, the user device receives the application template options page from the server 110, which may include a choice of templates to use as the starting point of the application. Also as part of step 410, the user enters a selection and sends the selection to the server. In step 416, the user device 114 receives more template options as part of the Application Builder page, via user device 114. For example, the user may be offered an option to add objects to the application. The choices offered may include an option to create a new object and/or to add an already created object. There may be a library of objects that were created by other users and/or that a collection of objects and/or templates for objects may be included with the application upon installation. In step 418, the template options are displayed on the user interface, in step 418. After selecting the desired template, in step 420, the user device 114 then sends template preferences to the server. Steps 416, 418 and 420 may be repeated multiple times. In repeating steps 416, 418, and 420 each repeat one or more of steps 416, 418, and 420 may be skipped.

Returning to step 408, if the user chooses to use a spreadsheet to create the application, in step 421a, the user device receives a spreadsheet that may be used for creating an application. Also, as part of step 421a the user makes entries into the spreadsheet and uploads the entries to the server. After step 421a, the method 400 proceeds to step 422.

Returning to step 408, if the user chooses to create the application from scratch, in step 421b, the user device receives a webpage for creating an application from scratch, which may provide tools to assist with creating the application. Also, as part of step 421b the user makes entries creating the application and uploads the entries to the server. After step 421b, the method 400 proceeds to step 422.

In step 422, the user creates an application by selecting a link (e.g., a button), which sends a message to server 110 requesting that an application be created according to the preferences selected in the prior steps. Depending on whether the user chose to add a new object to the application (prior to creating the application), a different branch of the flowchart is followed. If the user chose to add a new object to the application, then in step 426 user device 114 then receives a list of pages that can be edited. In another embodiment, the user may be able to create the specifics of a new object, add, and/or edit pages in objects prior to selecting a link to create the application. As part of step 426, the user selects a page and/or object to edits, and sends the choice to the page to server 110. In response, in step 428, the user device 114 receives a webpage with elements for editing and/or creating the application page selected, by adding elements to the application page. The elements may include fields and elements, such as text fields, check boxes, radio buttons, static and dynamic elements.

In step 430, in step in step the fields received by the user device are displayed. In step 432, the user device 114 detects and sends new object input and selected existing objects to the server 110. Steps 426, 428, 430, and 432 may be repeated multiple times (not necessarily in the same order), adding, creating, editing, and removing multiple elements in multiple objects. At one or more points while implementing steps 426, 428, 430, and 432, the user may be presented with, or be able to navigate to, a page having a create or update application link.

Steps 434-442 are implemented when the user device 114 navigates to a page having a button to create or update the application (which may be during steps 426-432), and the user decides to select the button to create and/or update the application. In step 436, the application link (e.g., button) is displayed on user device 114, and the user selects. In step 438, the user interface detects that the user has selected the create or update application link. In response, in step 440, user device 114 sends a request to update or create the application. In step 442, the user device receives the final generated application from the server 110.

In at least one embodiment, each of the steps of method 400 is a distinct step. In another embodiment, although depicted as distinct steps in FIG. 4, steps 402-442 may not be distinct steps. In other embodiments, method 400 may not have all of the above steps and/or may have other steps in addition to or instead of those listed above. The steps of method 400 may be performed in another order. Subsets of the steps listed above as part of method 400 may be used to form their own method.

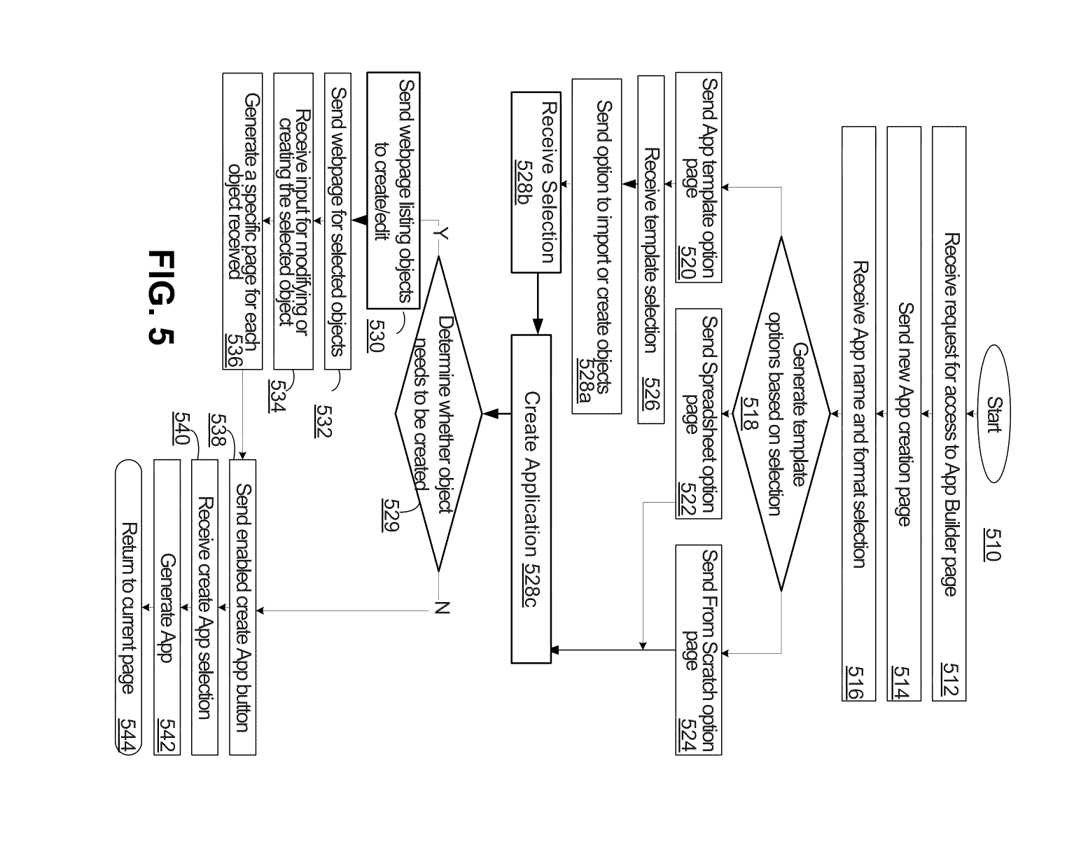

FIG. 5 shows a flowchart of an embodiment of method 510 for building an application from the server 110's point of view. In step 512, the server 110 first receives the user device's request for access to the Application Builder page (which may be received via a social network or another selection requesting a page for creating an application). In at least one embodiment, the request is received through user device 114. In step 514, the server 110 sends the new application creation page to the user device. In step 514, server 110 sends to the user device 114 a choice of how to create the application. The server 110 may send a page offering the user a choice of whether to create the application from a template, a spreadsheet, from scratch, or another means. In step 516, the server 110 receives the application name and format selection from the user device. For example, the application name may be received in a text box identified as a location for entering the application name.

In step 518, the server 110 determines which method of creating an application was selected, and depending on the selection, server 110 sends the appropriate webpage to user device 114. If in step 518, it is determined that the user selected to create the application from a template, method 510 proceeds to step 520. In step 520, the server 110 can then send the application template option page to the user device, in step, which may include a choice of templates. For example, the template webpage may include a predefined set of templates for use in application generation. Alternatively, if in step 518, it is determined that the user selected to create the application from a template, method 510 proceeds to step 522. In step 522, the server 110 sends the spreadsheet page to the user device 114, thereby enabling the user to create the an application using the spreadsheet. Alternatively, in step 524, the server 110 can send a webpage for creating an application from scratch to the user device 114. In step 526, the server 110 receives the template selection from the user device. In step 528a, the server 110 sends to the user device 114 the option to import objects and to create objects. In step 528b, server 110 receives the selection from user device 114. After step 522, after step 524, or after step 528b, method 510 proceeds to step 528c. In step 528c, the user is sent a link create the application. Also, in step 528c, the server 110 receives the user selection of the link, and creates the application with the already created objects and with pages for the new objects, even though the new objects need to be further built. In an alternative embodiment, the user may also build the new objects before creating the application. The user may have also been sent the link to create the application at earlier and/or later steps, and server 110 may receive are request to build the application at earlier and/or later times.

In step 529, the server 110 determines whether there is a new object that needs to be built. If it is determined that there is a new object that needs to be built, then method 510 proceeds to step 530. In step 530, the user is sent a list of objects to create and/or edit, and (if a selection of an object is made by the user) in response server 110 receives a selection of an object to create and/or edit (although not explicitly indicated in the flowchart, the user could also choose to move to a different task instead). In step 532, in response to receiving a selection of an object, the server sends a webpage for creating and/or editing the selected objects to the user device 114. In step 534, the server receives the selected existing objects and any newly created objects from the user device. In step 536, the server generates a specific page on the Application Builder for each object received. Steps 530, 532, 534, and 536 may be implemented multiple times, optionally, in different orders to modify and/or create multiple objects.

In an embodiment, steps 538-544 are implemented when the server 110 receives a request to generate the application, which may be when the server 110 has completed page generation for each object received. In step 538, the server sends the enabled create application link to the user device. Upon the user's decision to generate the application, the server receives the create application selection in step 540. The create application link may be available for the user to selected throughout steps 530-536. The application is generated in step 542, and the server sends the current page or the Page Builder page to the user device in step 544.

In at least one embodiment, each of the steps of method 510 is a distinct step. In another embodiment, although depicted as distinct steps in FIG. 5, steps 512-544 may not be distinct steps. In other embodiments, method 510 may not have all of the above steps and/or may have other steps in addition to or instead of those listed above. The steps of method 510 may be performed in another order. Subsets of the steps listed above as part of method 510 may be used to form their own method.

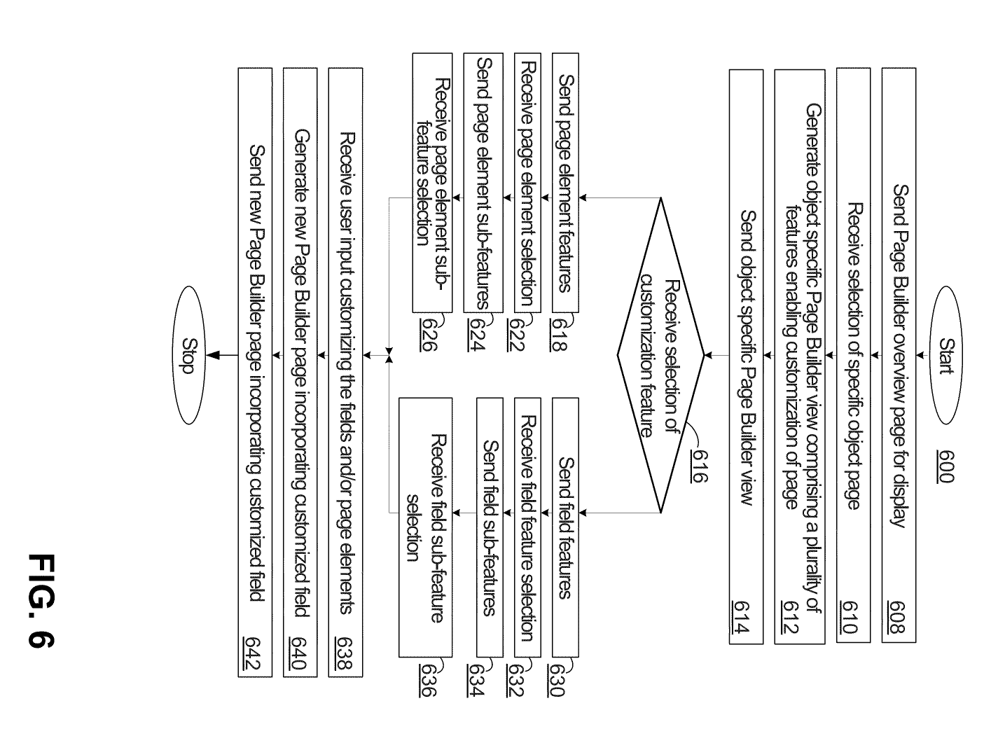

FIG. 6 shows a flowchart of an embodiment of method 600 in which the Page Builder is used by the server 110 to customize user-selected application features. In step 608, in response to receiving a request to edit an object, the server sends the Page Builder overview webpage (which is a webpage for building an application page) to the user device for display. In step 610, the server then receives the user's selection of specific object pages. In step 612, in response to step 610, the server sends a Page Builder webpage for editing the selected objects, thereby enabling customization of the application page with a plurality of features. In step 614, the server sends the object-specific Page Builder view to the user.

In step 616, the server receives the user's selection of a feature to add to, or modify on, the application page. In an embodiment, the feature may be a page element (such as an image, a content area, or a section) or a field (such as a text field or numerical field). Depending on whether the selection was for a page element or for a field method 600 proceeds to a different step. If it is determined that a page element was selected, method 600 proceeds to step 618. In step 618, the server 110 sends a webpage requesting the user to select features of element being created. For example, the page element features may include font, size, dimensions, a background, a text, a design, a color, etc. In step 622, the server 110 receives the user's selection of the features. Optionally, in step 624, the server 110 sends a webpage requesting that user make choices regarding sub-features of the page element. Optionally, in step 626, the server 110 receives a selection of the sub-features.

Returning to step 616, if it is determined that a field was selected, method 600 proceeds to step 630. In step 630, the server 110 sends a choice of features of the field of the user to select. Field features can include, whether the field the is dynamic, an auto computed number, a rollup. A formula, a relationship field, a lookup field, a master-detail field, static field, a text field a numeric field, a text area, a check box, a picklist, or a location, for example. In step 632, the server 110 receives the selected field features from the user device. In optional step 634, the server 110 sends a choice of field sub-features in the Page Builder to user device 114 and, in step 636, server 110 receives a selection of the sub-features from the user device 114. In step 638, after the page element and field sub-features are sent to the user device 114, the server 110 then receives user input further customizing element of the field. For example, as part of step 638, server 110, if the field is for a formula, server 110 receives the specific formula or if the field is a static text field, the server 110 receives the specific text for the field. In step 640, the server then generates the new Page Builder webpage incorporating the customized field, as a representation of how the application page will appear when the file is incorporated. In step 642 server 110 sends the Page Builder to the user device 114.

In at least one embodiment, each of the steps of method 600 is a distinct step. In another embodiment, although depicted as distinct steps in FIG. 6, step 608-642 may not be distinct steps. In other embodiments, method 600 may not have all of the above steps and/or may have other steps in addition to or instead of those listed above. The steps of method 600 may be performed in another order. Subsets of the steps listed above as part of method 600 may be used to form their own method.

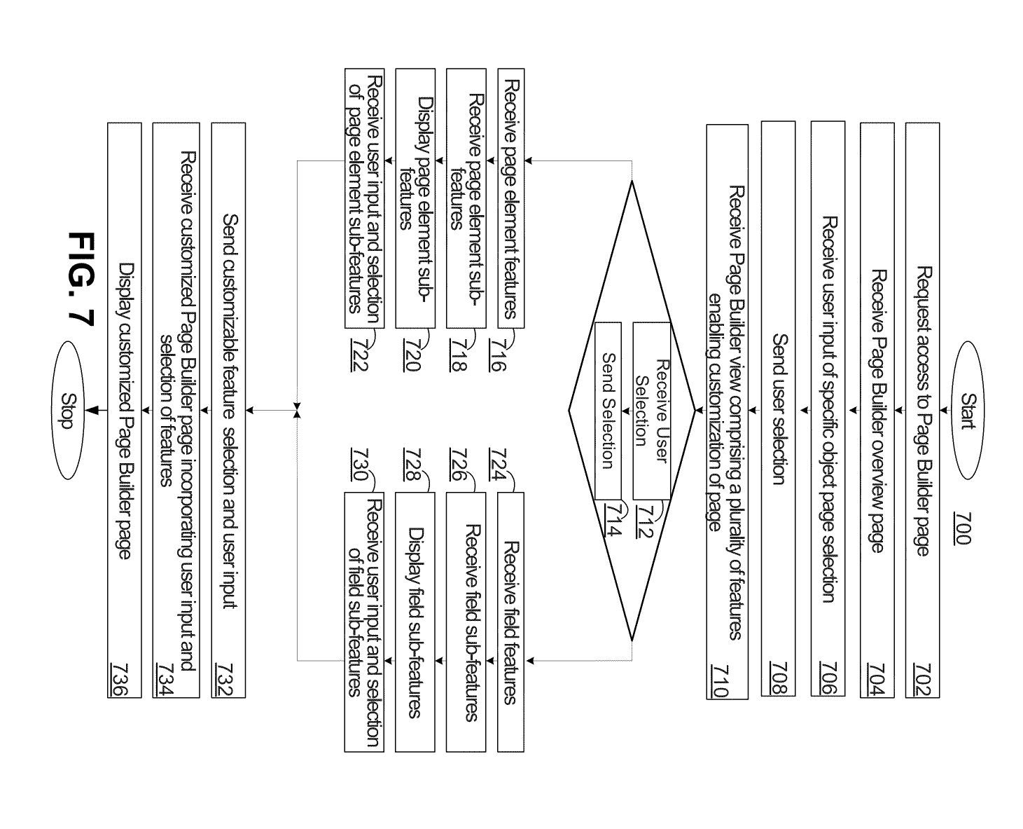

FIG. 7 shows a flowchart of an embodiment of method 700 in which the Page Builder is used by the user device to customize user-selected application features. In step 702, the user first requests access to the Page Builder page by interacting with a mobile device, computer system, or other interface. In step 704, the user device receives the Page Builder overview page. In step 706, the user device receives user input of specific object page selection, and then sends said selection to the server in step 708. In step 710, the user receives the Page Builder view, which comprises a plurality of features for selection, thereby enabling customization of the page.

In step 712, the user device receives user selection for formatting options and then sends said selection to the server in step 714. In at least one embodiment, the user then receives page element features and sub-features in steps 716 and 718, respectively. For example, the page element features may include font, size, dimensions, design, etc. In step 720, the user displays the page element sub-features, and then receives user input and page element sub-feature selection in step 722.

In a second embodiment, the user receives field features and sub-features from the server in steps 724 and 726, respectively. Field features can include, for example, work order, priority sequence, location, problem description, etc. In step 728, the user displays field sub-features on the interface between the user and server. In step 730, the user receives input and selection of field sub-features. After the user device has received the input/selection of page element and field sub-features, the user sends the customizable feature selection and user input to the server pursuant to step 732. In step 734, the user receives the customized Page Builder page with the incorporated user input and feature selection. In step 736, the interface displays the customized Page Builder page for the user to view.

In at least one embodiment, each of the steps of method 700 is a distinct step. In another embodiment, although depicted as distinct steps in FIG. 7, step 702-736 may not be distinct steps. In other embodiments, method 700 may not have all of the above steps and/or may have other steps in addition to or instead of those listed above. The steps of method 700 may be performed in another order. Subsets of the steps listed above as part of method 700 may be used to form their own method.

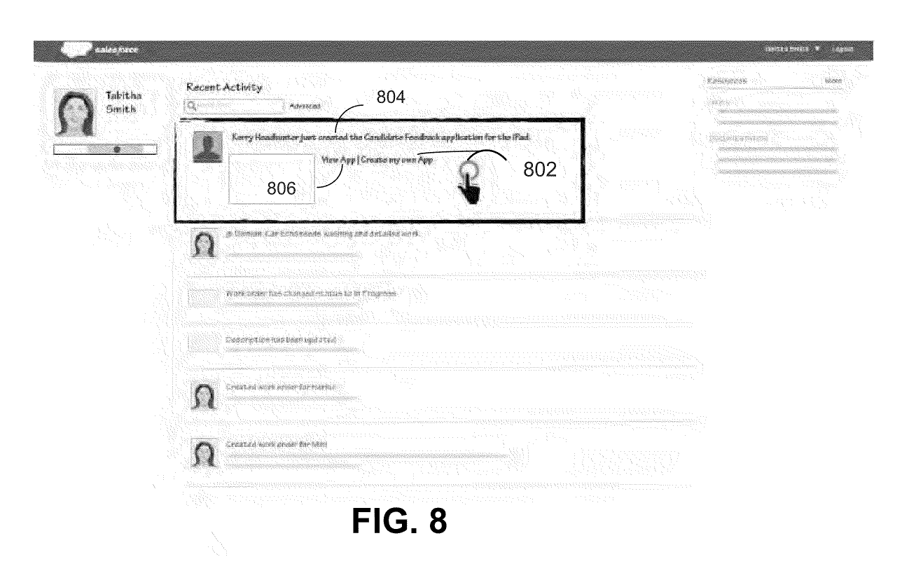

FIG. 8 shows a screenshot of an embodiment of a webpage of a social network 800. Webpage 800 includes a create new app link 802, post 804, and view app link 806. In other embodiments, social network 800 may not have all of the elements listed and/or may have other elements instead of, or in addition to, those listed.

Social network 800 may be any social network, such as Facebook, Twitter, Linkedin, or Chatter, for example. In an embodiment, social network 800 is associated with the multi-tentant database 206 (FIG. 2). Create new app link 802, when selected bring the user to a webpage of server 110 for creating an application. The screenshot displays the profile associated with the user of the Application Builder. Create new app link 802 allows the user to commence the generation of a customized application. Post 804 is a post on social network 800 by a user that created an application for other members of the social network to use. Create app link 802 is associated with post 804. In an embodiment, create app link 802 automatically appears in post 804 as a result of posting the application. View app link 806, when selected activates the application posted.

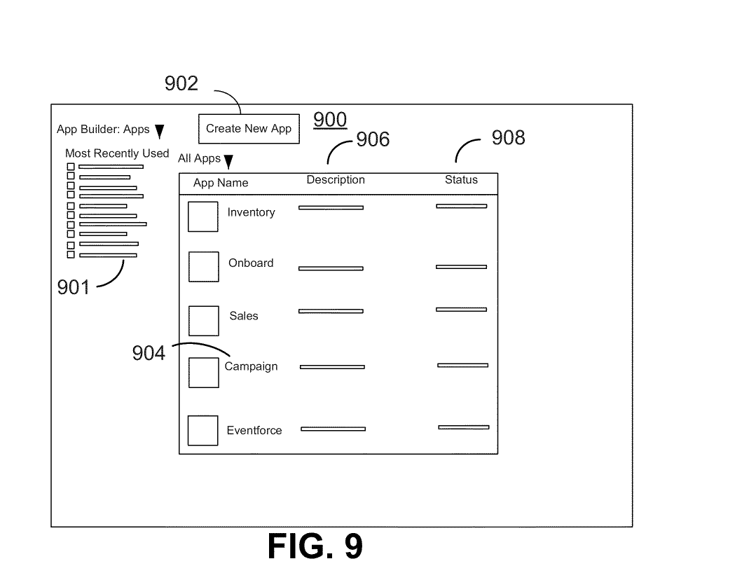

FIG. 9 shows a screenshot of an example of a homepage 900 of a webpage for creating and editing applications. Homepage 900 may include recently used application list 901, create application link 902, application 904, description 906, status 908. In other embodiments, homepage 900 may not have all of the elements listed and/or may have other elements instead of, or in addition to, those listed.

Homepage 900 is a homepage of a web application for creating applications for other devices, such as smart phones and tablet computers. Homepage 900 displays a variety of types of information that a user may want to interact with. Homepage 900 may include links to other applications the user can select from when generating an application. In at least one embodiment, homepage 900 may include a variety of application templates that are located in different boxes. Selecting one of the application templates in one of the boxes causes a webpage to be presented that shows information about the application template. (In an embodiment, when the user's cursor hovers over an icon for one of the applications some of the information listed in the application template webpage may be displayed, such as the template author and the number of votes received for and/or against the document.)

Recently used application list 901 is a list of applications presented to the user based on the number of times the user has selected to create a particular application. Create application link 902 is optional. When create application link 902 is selected, a message is sent to server 110 to send a webpage that start the process of creating an application. Application 904 is one of the applications created by server 110. Homepage 900 includes a list of applications, and application 904 is an example of one of the applications. Description 906 is a description of one of the applications. Status 908 is the status of one of the application. Status 908 may have values, such as complete on in-progress, for example.

FIG. 10 also shows screenshot of an embodiment of interface 1000 of a website for building applications. Interface 1000 may include new application prompt 1002, close prompt 1002a, application name box 1003 having an input name field 1004, application method options 1005 having method options 1006, and create application link 1008. In other embodiments, interface 1000 may not have all of the elements listed and/or may have other elements instead of, or in addition to, those listed.

New application prompt 1002 appears in response to selecting new application link create application link 802 (FIG. 8) and/or 902 (FIG. 9). Although the user can create an application through the new application prompt 1002, the user may decide to select the close prompt 1002a and select from a list of application and/or application templates 901 that the specific user recently used. (In another embodiment, the recently used application list 901, may include applications and/or templates displayed to the user based on a plurality of factors which may include overall times used by the community of users, overall times used in a specific time range, and user specific factors.)

New application prompt 1002 is an interface that allows users to define certain aspects of the application being generated. In other words, when a user selects a link to create an application 802 (FIG. 8), the user is brought to homepage 900 (interface) and new application prompt 1002 is displayed. Close prompt 1002a (already discussed), if selected, closes new application prompt 1002 enabling the user to select from recently used applications 901 or links to other applications 1210. Application name box 1003 includes one or more fields that allow a user to enter the application name. As a result of interaction with application name box 1003, a name will be associated (stored) with the application. For example, input name field 1004 allows a user to enter a combination of letters, symbols, and/or numbers which will be stored with the application and will allow the user to find and interact with the names application in future embodiments. In at least one embodiment, if no combination of letters, symbols, or numbers is entered, a generic name will be given to the application, such as “untitled” or “application.”

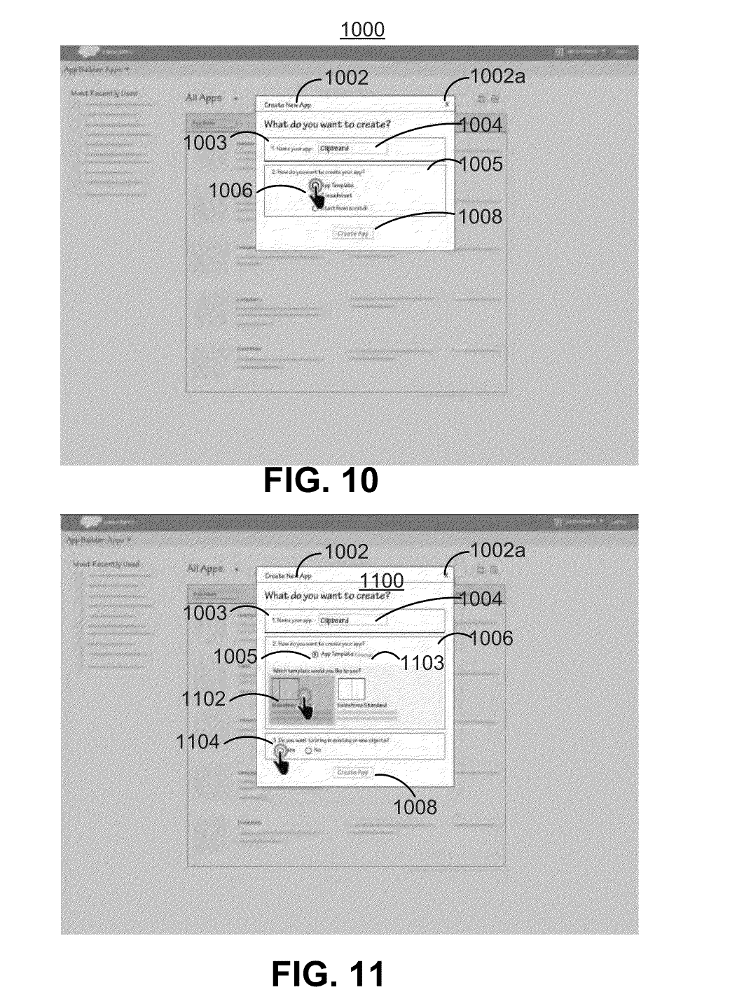

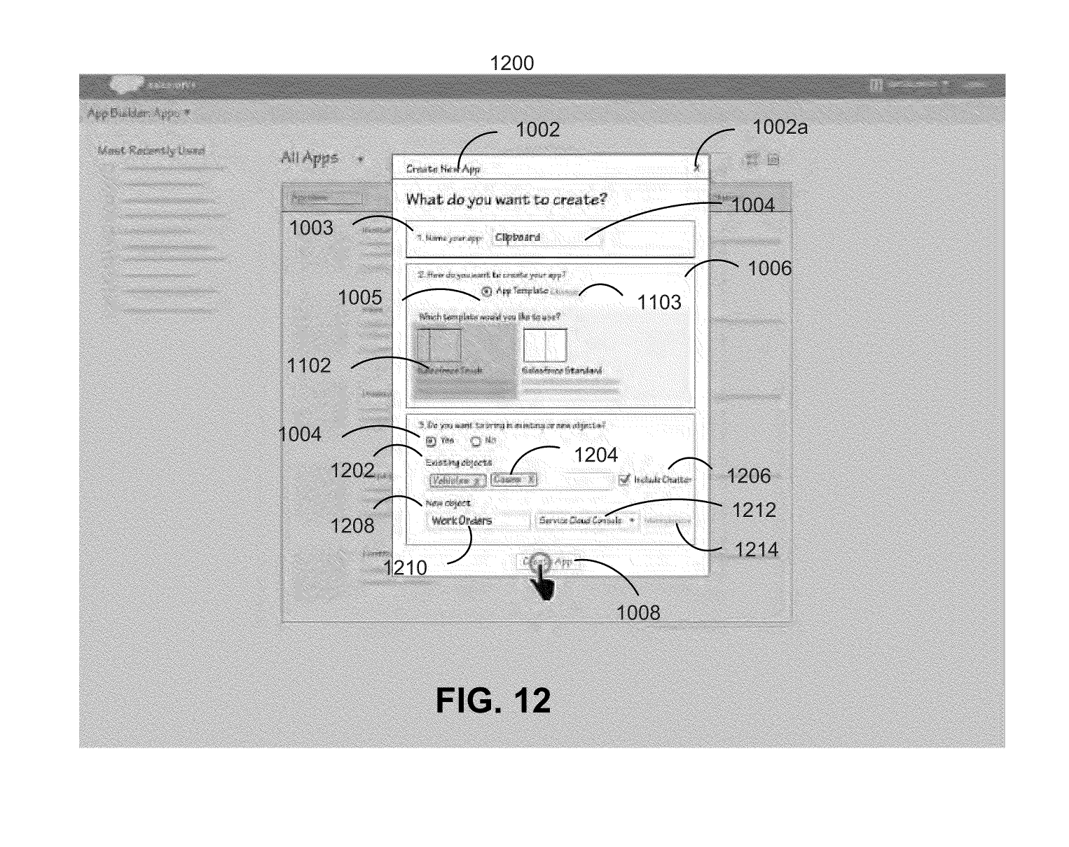

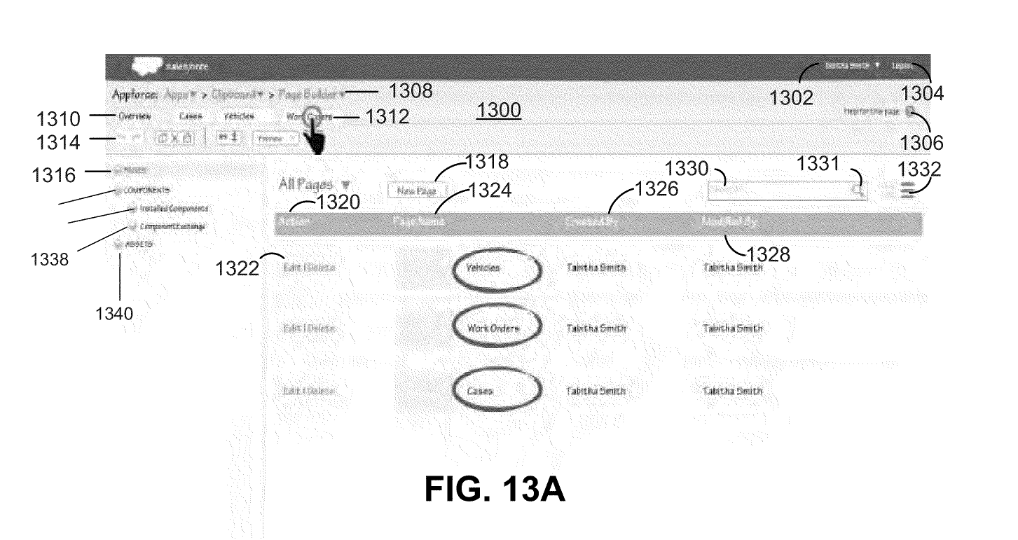

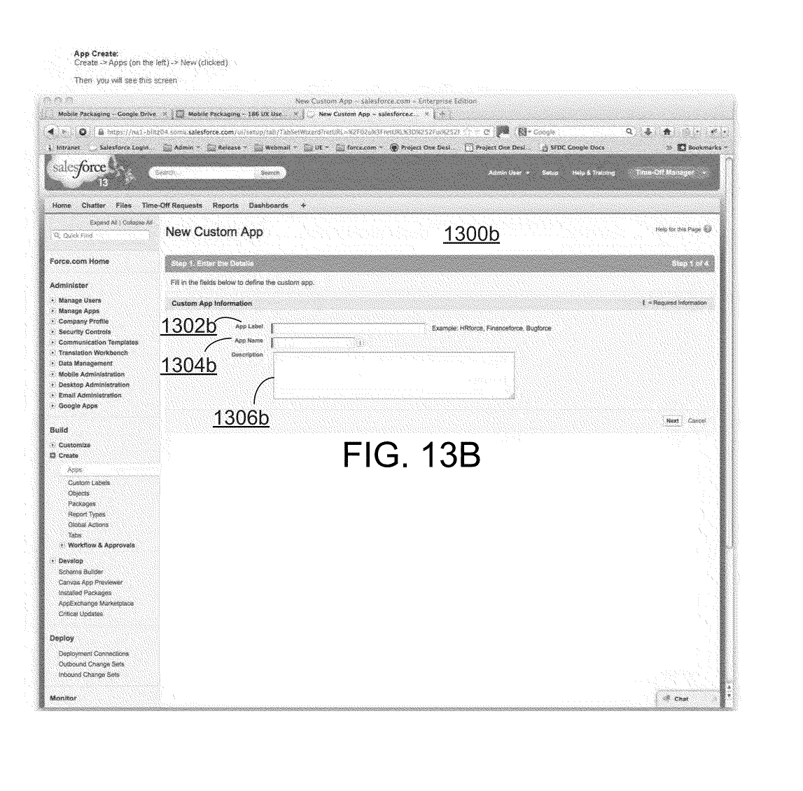

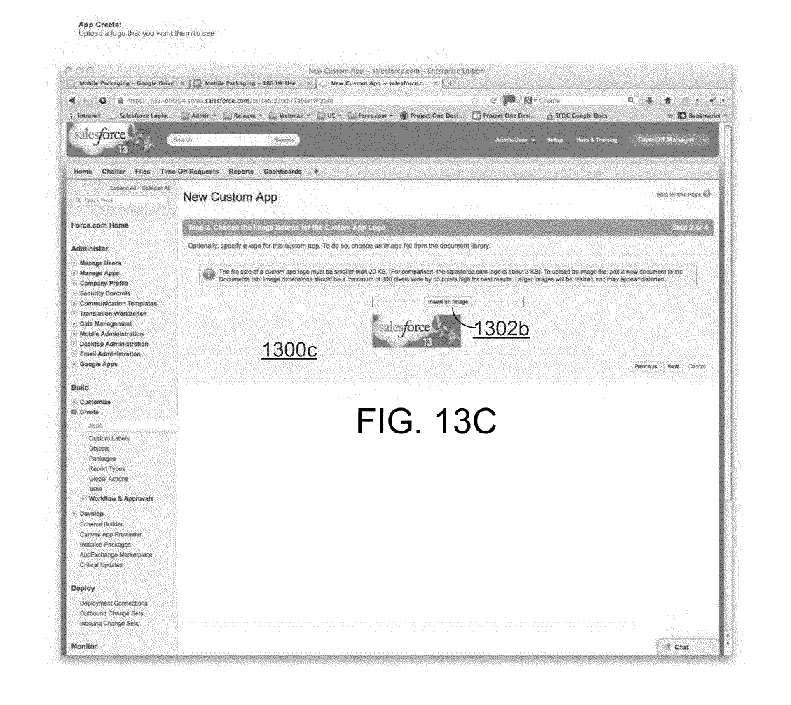

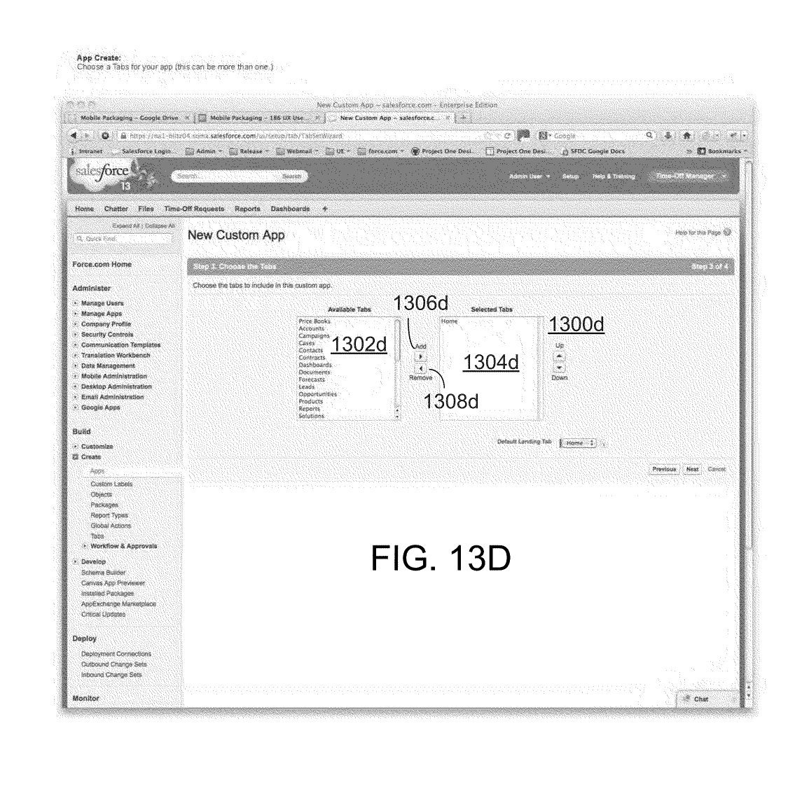

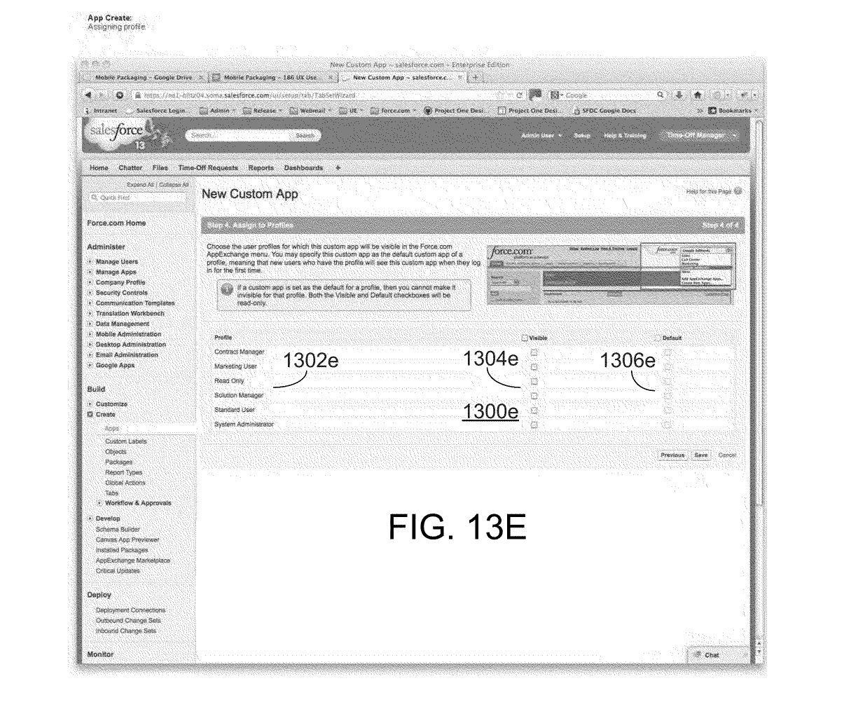

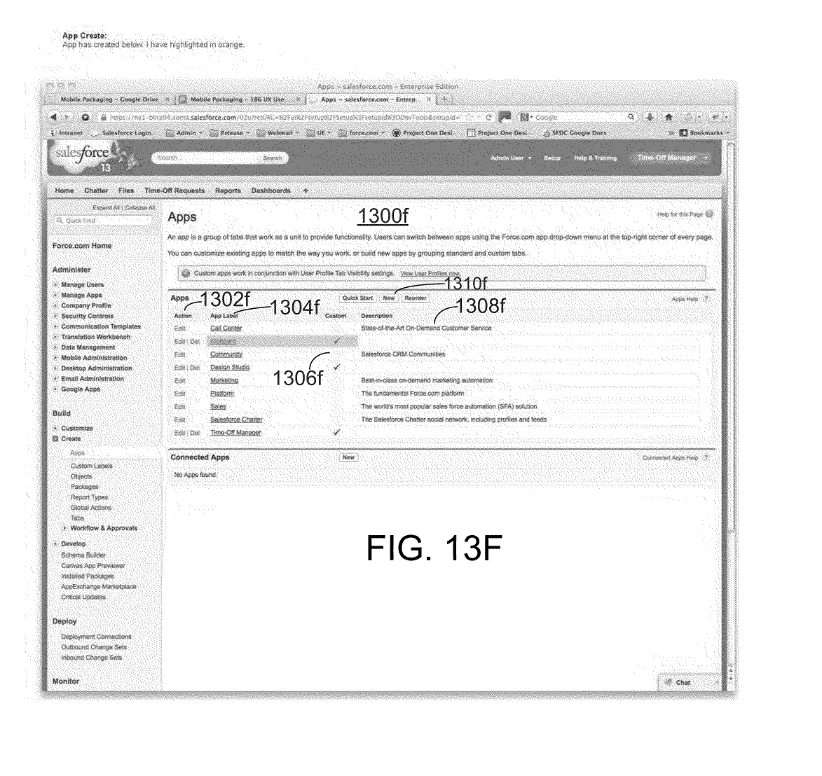

Application method options 1005 is a region in new application prompt 1002 that contains a pre-defined selection of options of methods for creating an application. Method options 1006 are the methods that the user may select, which are listed in application method options 1005. Method options 1006 may be capable of being utilized when generating a new application. When a method option 1006 is selected, the method options 1005 expands to display additional options based on the user selection (the webpage associated with the expanded method options 1005 will be discussed in conjunction with FIG. 11). Create application link 1008, when selected, brings the user to an application overview webpage that includes links and/or instructions for further customization of the application being generated (the webpage associated with the overview webpage will be discussed in conjunction with FIG. 13A). In at least one embodiment, the create application link 1008 is enabled after the user enters information into the input name field 1004. In another embodiment, the create application link 1008 is enabled after the user selects a method option 1006. Alternatively, the create application link 1008 is always enabled allowing the blank application to be found and edited at a later time.

FIG. 11 shows an example of interface 1100 providing expanded options for creating an application. Interface 1100 may include new application prompt 1002, close prompt 1002a, application name box 1003 having an input name field 1004, application method options 1005 having method options 1006, and create application link 1008. Interface 1100 may also include template choices 1102 having a change 1103 and object import box 1104. In other embodiments, interface 1100 may not have all of the elements listed and/or may have other elements instead of, or in addition to, those listed.

New application prompt 1002, close prompt 1002a, application name box 1003, input name field 1004, application method options 1005, method options 1006, create application link 1008, and were explained above in conjunction with FIG. 10.

Template choices 1102 allows the user to select from predefined templates for use in application generation. In at least one embodiment, when the user selects a desired format, method option 1006 is expanded allowing a limited number of available template choices 1102 to be displayed. In other words, the display of template choices 1102 is dependent on the user decision to generate the application using a template. Change 1103, when selected, causes server 110 to offer other choices for the method used for creating the application. For example, the user may decide to start making an application from a spread sheet rather than form a template. Template choices 1102 present to the user a choice of templates that the user may select as the template for creating the user's application. In other words, a limited number of available template choices 1102 are displayed upon user selection of template from method options 1006 as the method for creating the application, if the user desired template option is not among those displayed, the user can select change 1103 to select from a larger pool of available template options. The user selection will then be displayed in the expanded method option 1006, enabling user to select desired template now available in template option field. Change 1103 allows the user to change selection of the method of making the application that had previously been chosen from method option 1006 (FIG. 10). In other words, change 1103 enables the user to change the selection of method option 1006 and select from other possible methods of generating a new application.

Object import box 1104 allows the user to choose whether to add objects to the application in addition to the objects already included in the template used for making the application. In other words, object import box 1104 enables the user to import objects for use within the application being generated. Selecting object import box 1104 causes server 110 to send to user machine 114 one or more webpages with options that the user may choose, which when selected cause server 110 to add one or more objects to the application. In at least one embodiment, the user may select from previously created objects, and then the data associated with the object will be incorporated within the application being generated. In other embodiments, the user may select from predefined objects, lacking any associated data, and at a later time the user may decide whether to create data to be associated with the selected object.

FIG. 12 shows an example of interface 1200 for providing expanded options for creating and/or importing objects. Interface 1200 may include new application prompt 1002, close prompt 1002a, application name box 1003, input name field 1004, application method options 1005, method options 1006, create application link 1008, links to other applications 1210, template choices 1102 having a change 1103, and object import box 1104. Interface 1200 may also include existing object box 1202 having a selected objects 1204, include social network 1206, new object box 1208 having a new object name field 1210, new object type 1212, and additional object creation box 1214. In other embodiments, interface 1200 may not have all of the elements listed and/or may have other elements instead of, or in addition to, those listed.

Homepage 900 (interface), recently used application list 901, new application prompt 1002, close prompt 1002a, application name box 1003 having an input name field 1004, application method options 1005 having method options 1006, create application link 1008, links to other applications 1210, template choices 1102 having a change 1103 and object import box 1104 were explained above in conjunction with FIGS. 11-13.

Existing object box 1202 indicates whether the to include objects that already exist. Multi-tenant database 1006 may several objects that have already been created and/or other users associated with the tenant may have already created objects, which are now available for other users to choose from. The multi-tenant database may provides a series of objects for incorporation into applications, which act as interfaces to objects that are provided to each tenant. Selected objects 1204 is a field in which the objects that were already created are listed, which were selected by the user. The user adds any already created objects desired to object field 1204, and application builder 202 will incorporate those objects into the applications generated. Existing object box 1202 coupled with a selected objects 1204, allows the user to select a plurality of objects previously created. In at least one embodiment, when the user affirmatively selects object import box 1104, interface 1200 is expanded and the user may enter previously created objects in selected objects 1204. Alternatively, objects previously created by the user may be automatically listed in selected objects 1204, and is then presented the option to deselect any existing objects the user does not wish to be incorporated into the application being generated and add other objects that the user also wants incorporated in the application. In other words, existing object box 1202 and selected objects 1204 provide a user the ability to incorporate existing objects and the data associated with those objects thereby enabling the generation of a functional application by leveraging the existing information contained in previously generated objects.

Include social network 1206, allows the user the option of including Chatter. In at least one embodiment, Chatter enables real-time enterprise collaboration within the application being generated. By selecting include social network 1206, a link to social network is included in the application created. Additionally, when posting the application to that social network for others to use, a link for creating a new application may also be posted.

New object box 1208 is a box for listing new objects that the user wishes to create. New object name field 1210 allows the user to choose a name for the new object. New object box 1208 coupled with new object name field 1210, causes the application builder 202 to initiate the creation of new objects that will be incorporated in the application being generated. In at least one embodiment, new object name field 1210 enables the user to input a title for the object being created which will then be associated with that specific object that will be created later. In at least one embodiment, the user is not limited by the number of objects previously created when generating an application. Rather, the user may include existing objects and/or generate a new object. New-object type 1212 designates a type to the object being created. The type may be indicative of the properties of the object, such as the types of data and/or method accessing the data retrieved by the object. An example of an object type is “cloud console.” Additional object creation box 1214 enables the user to list names of additional objects that the user would like to create and use within the application being generated. Selecting additional object creation box 1214 may cause another pair of boxes (a second new object creation box and new object type box) to appear in new object box 1208.

FIG. 13A shows an example application overview page 1300 of a website for building applications. Application overview page 1300 may include user indicator 1302, logout 1304, help 1306, navigation tab 1308, overview tab 1310, object tabs 1312, function bar 1314, overview selection 1316, new page tab 1318, actions 1320, edit/delete tab 1322, page name 1324, created by indicator 1326, modified by indicator 1328, search bar 1330, search button 1331, view indicator 1332, components 1334, installed components 1336, component exchange 1338, and assets 1340. In other embodiments, application overview page 1300 may not have all of the elements listed and/or may have other elements instead of, or in addition to, those listed.

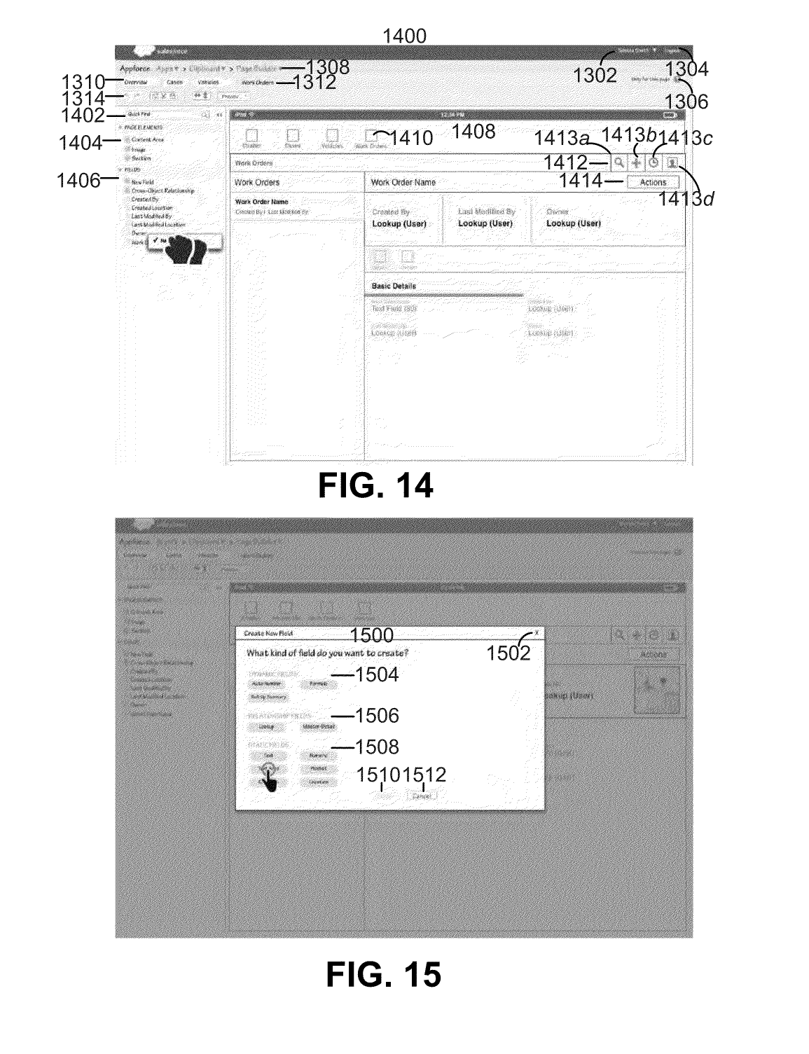

Application overview page 1300 displays information about pages created from objects imported or created (FIG. 12). User indicator 1302 includes the name or an identifier the user currently interacting with application overview page 1300. Logout button 1304 enables the user to exit application builder 202. Help button 1306 causes a help webpage to be rendered. Navigation tab 1308 includes a visual representation of the current path, where the user currently is within the application builder 202. Additionally, navigation tab 1308 enables the user to navigate between various stages in the process of generating an application. Overview tab 1310 causes the display of information shown in FIG. 13A and allows the user to view a limited amount of information regarding a plurality of pages. Object tabs 1312 are created for all imported and newly created objects that are now represented as pages on overview page 1300. Selecting one of object tabs 1312 causes a webpage representing the object to be rendered. An example of a webpage representing an object will be discussed below in conjunction with FIG. 14. Function bar 1314 provides a limited amount of editing functionality within overview page 1300. In at least one embodiment, function bar 1314 enables such functions as copy, cut, paste and preview. In other embodiments, function bar 1314 may not have all of the elements listed and/or may have other elements instead of, or in addition to, those listed.

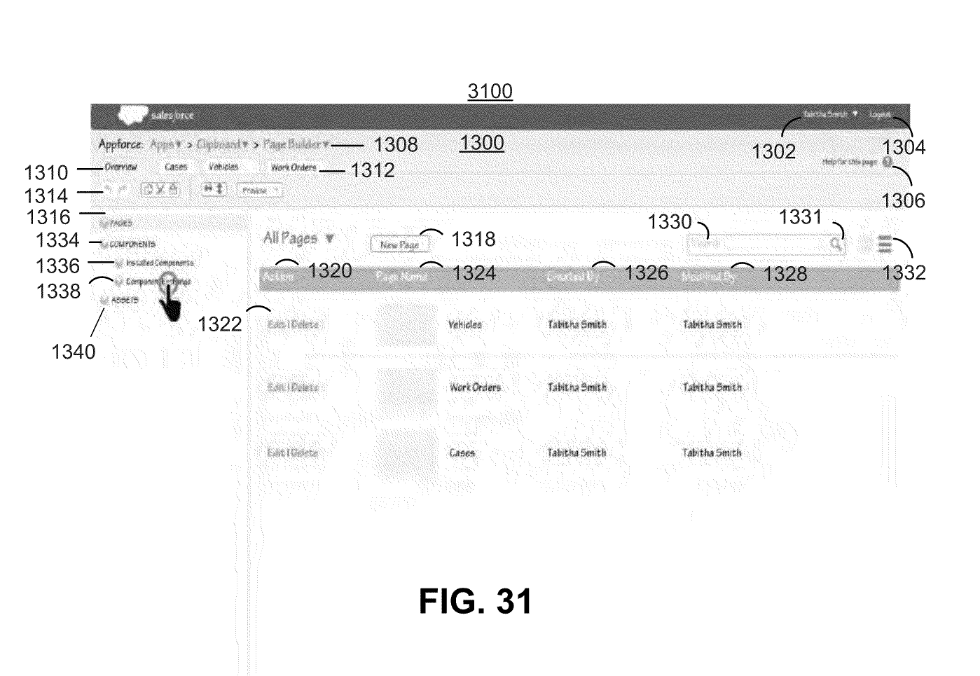

Overview selection 1316 allows the user to navigate to various additional overview pages. In the current embodiment, “pages” is selected among the available options, which list the pages of the application. Selecting a different option within navigation field 1316, causes an overview page of the selected option to be rendered and a plurality of elements, specific to that selection, are thereby presented. The user may also select components to see a list of available components, which may include components installed in the application and other components made by others that are available in a component exchange. The user may also select to view a list of assets included in the application. Selecting from one of the options within the navigation field 1316 is discussed in conjunction with FIG. 31-34.

New page tab 1318 provides the user the ability to create and/or import additional objects. In other words, the user is not limited by the initial process described above (FIG. 12) when creating and/or importing objects. In at least one embodiment, selection of new page tab 1318 causes a webpage similar to object import box 1104 to be rendered, thereby allowing the user to import and/or create new objects that will be incorporated as new pages within the overview (home) tab 1310.

Actions 1320 displays a list of actions available to the user to perform, which may just be to edit or delete one of the pages listed. Edit/delete tab 1322 initiates a process that allows the user to delete or edit an object. Page name 1324 lists the names of pages of the application to which the action may be applied. Created by indicator 1326 associates a name or unique identifier with the user that created the specific page listed. Similarly, modified by indicator 1328 associates a name or unique identifier with the user that most recently modified a specific page. Search bar 1330 includes one or more links and/or fields that allow a user to formulate a search query to search for a particular page of the application. As a result of interacting with search bar 1330, a search may be conducted for elements meeting the search query. For example, search bar 1330 allows a user to enter a combination of key-words, which may be used as part of a search query to find a page of the application. Search button 1331, when selected, initiates a search based on a search query formulated from the current entries in search bar 1330. After the search has been initiated, a result webpage may be presented. View indicator 1332 provides a representation of current view being displayed. For example, view indicator 1332 may represent a list view, which is the case in FIG. 13A, while also enabling a user to select a tile view. When selected, tile view causes a new view to be rendered wherein the information is displayed as a plurality of tiles.

Components 1334, when selected, causes application builder 202 to produce a list of components and bring the user to a page in which the user can create new components or open and edit components that were already created. Installed components 1336 lists components that are installed in the current application. Component exchange 1338 is a location where users post components for other users to use the components. Assets 1340 brings the user to a page listing assets, allowing the user to create new assets and/or edit already created assets.

FIGS. 13B-13E are a series of screenshots for a four step process of creating an application. In FIGS. 13B-13E, in the first step the user names, labels, and describes the application. In the second step, the user optionally adds a logo to the application. In the third step, the user adds objects to the application. In the fourth step, the user determines which profiles can use and see the application.

FIG. 13B shows a screenshot of an embodiment of page 1300b for naming an application. Page 1300b may include name 1302b, label 1304b, and description 1306b. In other embodiments, object page 1300f may not have all of the elements listed and/or may have other elements instead of, or in addition to, those listed.

Name 1302b is the name of the application that is used by the application builder 202 to identify the application. Label 1304b is a text label placed on the application to identify the application to users. In an embodiment, name 1302b and label 1304b are required fields that must be filled in by the user. Description 1306b is a description of the application. Filling out page 1300b completes the first step of creating an application.

FIG. 13C shows a screenshot of an embodiment of page 1300c for adding a logo to an application. Page 1300c may include insert-an-image 1302c. In other embodiments, object page 1300c may not have all of the elements listed and/or may have other elements instead of, or in addition to, those listed.

Page 1300c is used for adding a logo to the application, which may be used to identify the application in a menu, for example. Insert-an-image 1302c, when selected, imports an image file that is used as the logo of the application. In an embodiment, opens a box that may be navigated to a location where an image file may be found. Once the image file is found, the user selects the image file, and the image file is imported into the application. Filling out page 1300c completes the second step of creating an application.

FIG. 13D shows a screenshot of an embodiment of page 1300d for adding objects to an application. Page 1300d may include available objects 1302d, incorporated objects 1304d, add icon 1306d, and remove icon 1308d. In other embodiments, object page 1300d may not have all of the elements listed and/or may have other elements instead of, or in addition to, those listed.

Available objects 1302d include a list of objects that are available for use in the application. Incorporated objects 1304d includes a list of objects that have already been incorporated into the application. The objects of available objects and incorporated objects may be database objects, such as database tables (e.g., which are associated with a relational database) or other objects. Add icon 1306d adds objects from the available objects to the incorporated object, incorporating the object into the application. The user selects an available object 1302d and then selects the add icon 1306d, and the selected object is added to the application, appearing in the incorporated objects 1304d. Remove icon 1308d removes objects form the incorporated objects placing the removed objects back into the available objects. The user selects an incorporated object 1304d and then selects the remove icon 1308d, and the selected object is removed from the application, removing the selected object from the incorporated objects 1304d placing the object in the available objects 1302d. Using page 1300d to add objects to the application completes the third step of creating an application.

FIG. 13E shows a screenshot of an embodiment of page 1300e for assigning the visibility of an application. Page 1300e may include profiles 1302e, visibility indication 1304e, and default indication 1306e. In other embodiments, object page 1300e may not have all of the elements listed and/or may have other elements instead of, or in addition to, those listed.

Profiles 1302e identify different the permissions of different types of users. Different roles (e.g., managers, salespeople, accountants, etc.) may be assigned different profiles, which may be associated with different privileges. Visibility indication 1304e indicates whether the application is visible to the associated profile (and thereby can be allowed to use the profile). Default indication 1306e indicates whether by default uses with that profile are given permission to use the application. Filling out page 1300e completes the fourth step of creating an application.

FIG. 13F shows a screenshot of an embodiment of page 1300f of applications. Page 1300f may include available actions 1302f, applications 1304f, custom indication 1306f, description 1308f, and buttons 1310f. In other embodiments, object page 1300f may not have all of the elements listed and/or may have other elements instead of, or in addition to, those listed.

Available actions 1302f are actions that are available for a given application, which may include edit and/or delete. Edit allows the user to edit the application associated with the available action, and delete allows the user to delete the associated application. Applications 1304f is a list of names of the applications, which may be links opening the application to use the application. Custom indication 1306f indicates whether the application was custom made or an application provided by the system for users to use. Description 1308f describes the purpose of the application. Buttons 1310f may include buttons for adding a new application, opening page 1300b for quickly starting a new application or reordering the order that the applications are listed in. Page 1300f allows the user to further customize the application after the application is created.

FIG. 14 shows an example object page 1400 of application builder 202. Object page 1400 may include user indicator 1302, logout 1304, help 1306, navigation tab 1308, overview tab 1310, object tabs 1312, function bar 1314, page search bar 1402, element list 1404, field list 1406, representative interface 1408, page selector 1410, task bar 1412, task elements 1413a-d, and action bar 1414. In other embodiments, object page 1400 may not have all of the elements listed and/or may have other elements instead of, or in addition to, those listed.

User indicator 1302, logout 1304, help 1306, navigation tab 1308, overview tab 1310, object tabs 1312 and function bar 1314 were explained above in conjunction with FIG. 13A.

Object page 1400 is a webpage that represents the corresponding page of the application. Object page 1400 may be used to add, delete, and/or modify features of a page of the application. Object page 1400 allows a user to visualize and/or interact with the application page created, which is coupled to the selected one of object tabs 1312. In other words, object page 1400 enables user to customize each page in a plurality of ways, thereby allowing the user to customize the application.

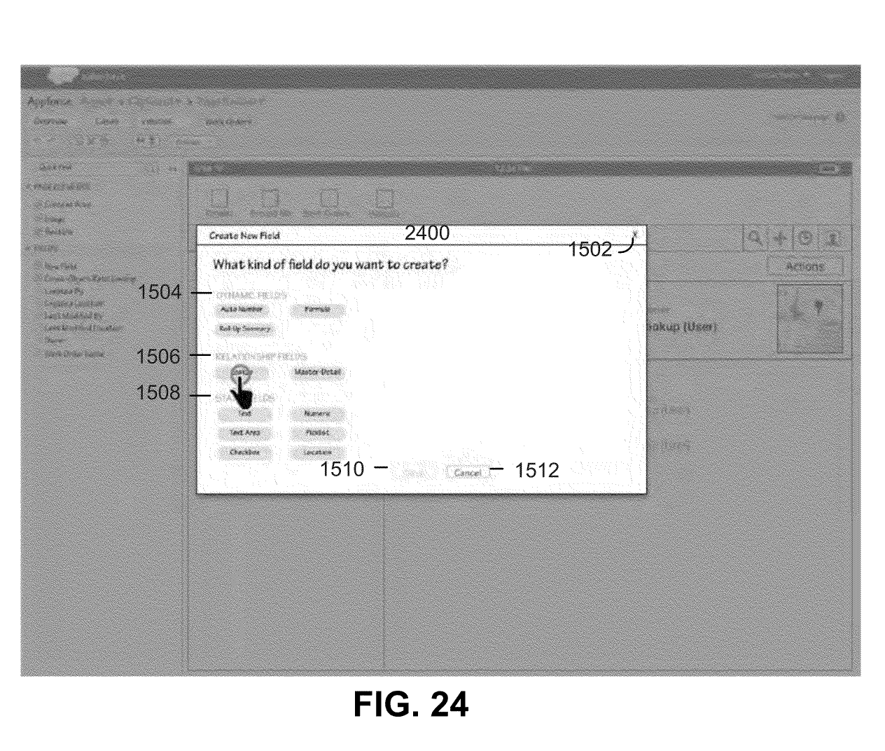

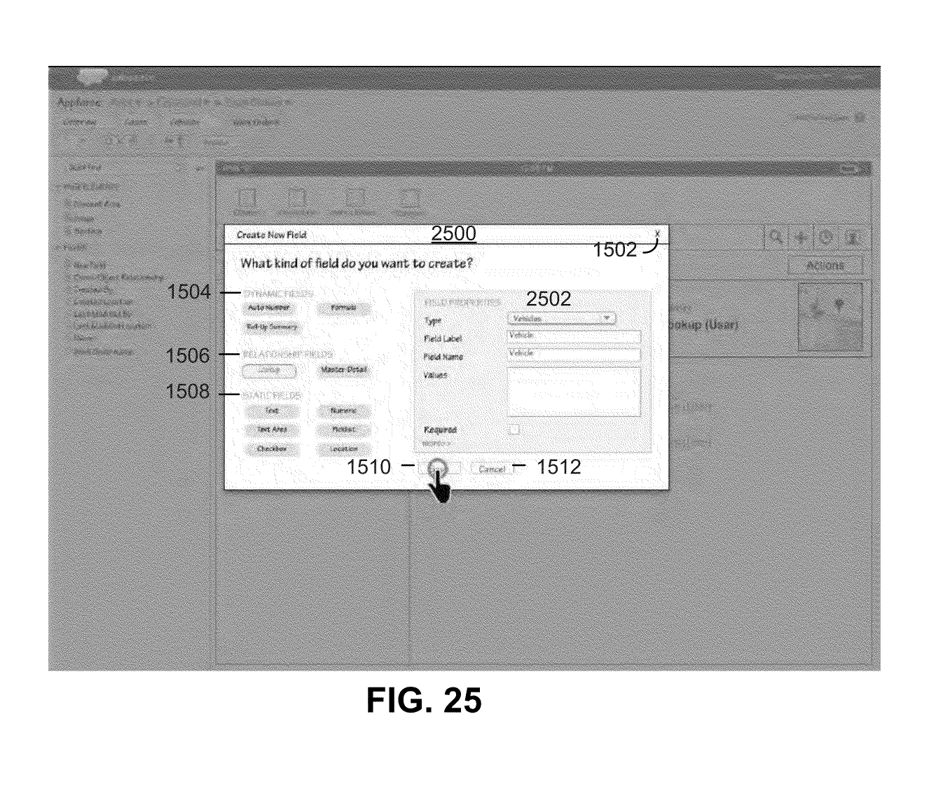

Search bar 1402 allows a user to search for features of the object page 1400. When selected, search bar 1402 initiates a search based on a search query formulated from the current entries in search bar 1402. Element list 1404 includes one or more links and/or fields representing components capable of being incorporated within object page 1400. In other words, a user can select from a plurality of page elements form element list 1404, and the selection will add an element (e.g., a static element) to the page which can be further customized. Field list 1406 includes one or more links and/or fields capable of being incorporated within object page 1400. In other words, a user can select from a plurality of field options from field list 1406, and the selection will add a field (e.g., an input field and/or a static field) to object page 1400. Interaction with and/or customization utilizing field list 1406 will be discussed below in conjunction with FIG. 15-19, FIG. 24, and FIG. 25.

Representative interface 1408 displays the layout of the specific page coupled with the selected object tab 1312. Additionally, representative interface 1408 enables a user the ability to interact with the various customizable features and/or components, discussed above, while visualizing how those features and/or components will look in the finished application. In at least one embodiment, representative interface 1408 is specific to the layout of a user system 114 that is an iPad, which is FIG. 14.

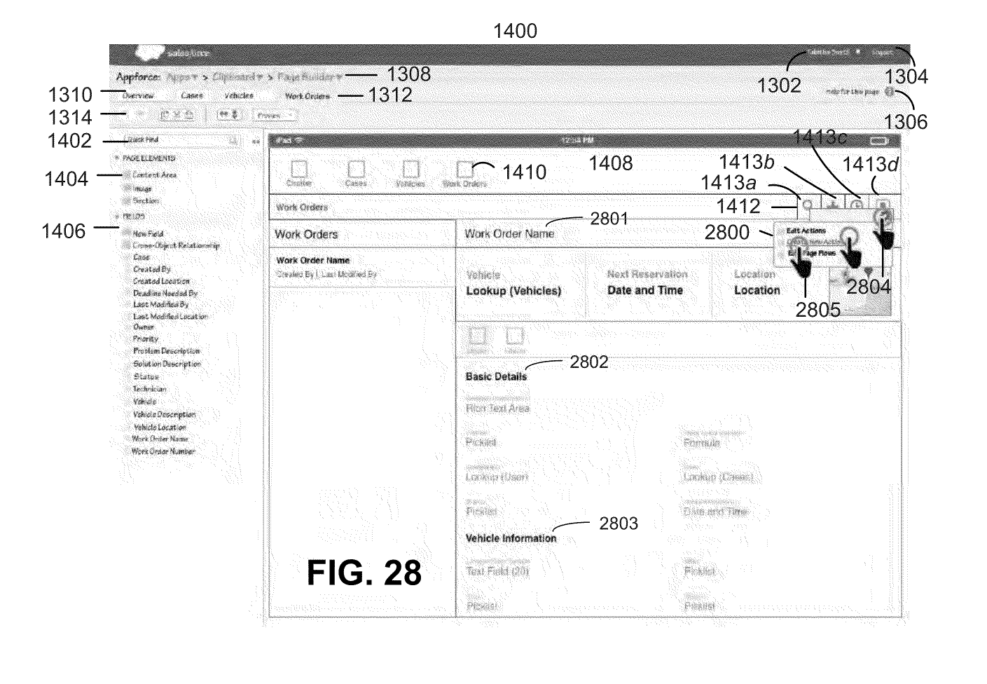

In at least one embodiment, representative interface 1408 may include page selector 1410, task bar 1412, task elements 1413a-d, action bar 1414, and a plurality of customizable fields. Page selector 1410 provides user the ability to navigate between pages while interacting with the finished application on user system 114. In other words, page selector 1410, when selected, initiates the rendering of the selected page to occur on user system 114. Task bar 1412 provides user the ability to interact with a finished application through one of the task elements 1413a-d. Task elements 1413a-d may be embodiments of function bar 1314. The icons used for task elements 1413a-d are suggestive of many different types of functions, such as search, add, copy, cut, paste and user logout. Action bar 1414 allows users to interact with various action, create new actions and/or edit the flow of actions within a specific page. Interacting with action bar 1414 is discussed in conjunction with FIG. 28-34. In the specific example of FIG. 14 object page 1400 is for work orders and includes fields for listing the name associated with the work order, and the users that created and modified the work order. The fields for listing the owner and the user that last modified the work order are lookup fields, which when selected lookup possible users to enter. The example page also include problem description area, which is a rich text field; a status and priority fields, which are pick lists; work order number field, which is a formula; an assigned to field, which is a lookup field; a reservation field, which is a data and time field; and a vehicle description field, which has not been assigned a type, yet.

FIG. 15-FIG. 17 relate to creating a new text area field.

FIG. 15 shows an example of a create new field page 1500. Create new field page 1500 may include close box 1502, dynamic fields 1504, relationship fields 1506, static fields 1508, save tab 1510, and close tab 1512. In other embodiments, create new field page 1500 may not have all of the elements listed and/or may have other elements instead of, or in addition to, those listed.

Create new field page 1500 may be used to create a specific field not present in object page 1406 (FIG. 14). Close box 1502, if selected, closes create new field page 1500 thereby initiating a process resulting in the return to object page 1400. Dynamic fields 1504 are defined by the data input into the field. For example, a common dynamic field example is inventory, once an item has been sold, the information is updated on server 110 (e.g., in multi-tenant database 206) and when the next user views the field, he/she will view the updated information. Dynamic fields 1504 may include auto number, formula and roll-up summary. Relationship fields 1506 enable a user to link one or more objects. In other words, relationship fields 1506 allow a user to build new objects from the information already present in conjunction with existing object pages. Relationship fields 1506 may include lookup and master-detail. In an embodiment, relationship fields 1506 may establish and/or mirror a relationship between multiple database objects in multi-tenant database 206 that correspond to the corresponding application objects between which the relationship is established. Static fields 1508 are fixed or defined before data input. In other words, static fields 1508 are limited fields wherein once the field is created, the user cannot change the content or structure of the field. Static fields 1508 may include text, text area, checkbox, numeric, picklist and location. Save tab 1510 initiates a process that stores created field and displays field in field list 1406 (FIG. 14). In at least one embodiment, save tab 1510 is only enabled after the user has interacted with create new field page 1500. Close tab 1512, if selected, closes create new field page 1500 (e.g., whether or not the created field was saved) thereby initiating a process resulting in the return to object page 1400.

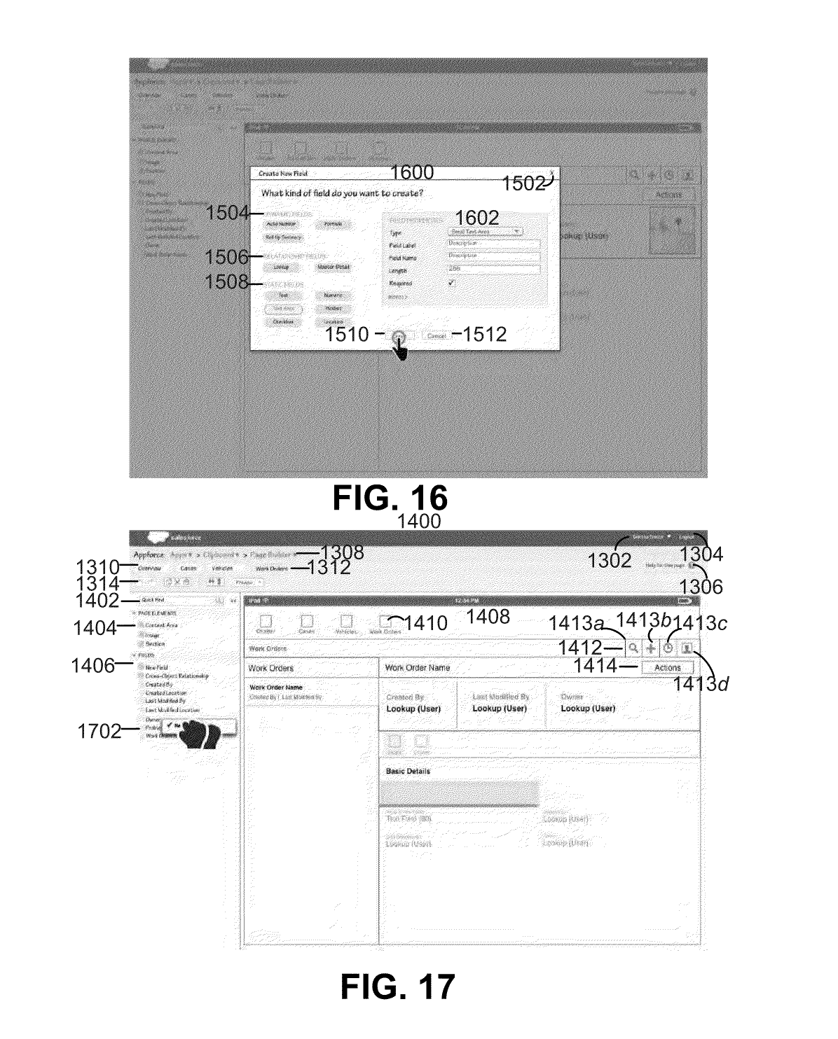

FIG. 16 is a screenshot of an example of interaction 1600 with create new field page 1500. Interaction 1600 includes close box 1502, dynamic fields 1504, relationship fields 1506, static fields 1508, save tab 1510, close tab 1512 and field properties box 1602. Create new field page 1500, close box 1502, dynamic fields 1504, relationship fields 1506, static fields 1508, save tab 1510, and close tab 1512 were explained above in conjunction with FIG. 15. In other embodiments, interaction 1600 may not have all of the elements listed and/or may have other elements instead of, or in addition to, those listed.

Interaction 1600 occurs when the user selects a specific field, which is “text area” in FIG. 16, to add to object tab 1312. In other words, selecting a field causes interaction 1600 to be rendered, and as a result field properties box 1602 is presented to the user. Field properties box 1602 may allow users to enter information about the selected field being created. In the example of interaction 1600, field properties 1602 specific to user selection of “text area.” In at least one embodiment, field properties 1602 may include a type of text area (e.g., a small text area), a field label, a field name, a length, and an option to make field required. Field properties 1602 may also include more detailed properties available through selection of one or more links within field properties box 1602. Field properties box 1602 may allow users to manually enter information and/or select from available options within a picklist. In other embodiments, interaction 1600 may not have all of the elements listed and/or may have other elements instead of, or in addition to, those listed.

FIG. 17 shows an example object page 1400 of a website for building applications. Object page 1400 may include user indicator 1302, logout 1304, help 1306, navigation tab 1308, overview tab 1310, object tabs 1312, function bar 1314, page search bar 1402, element list 1404, field list 1406, representative interface 1408, page selector 1410, task bar 1412, task elements 1413a-d, action bar 1414 and updated field list 1702. In other embodiments, object page 1400 may not have all of the elements listed in FIG. 17 and/or may have other elements instead of, or in addition to, those listed.

FIG. 17 incorporates all elements explained above in conjunction with FIG. 14 and represents one embodiment where the new field created 1702 (by FIGS. 15 and 16) is now stored and displayed in an updated field list 1406. In other words, once saved, a new field created by the user through interaction 1600 is made available for object customization.

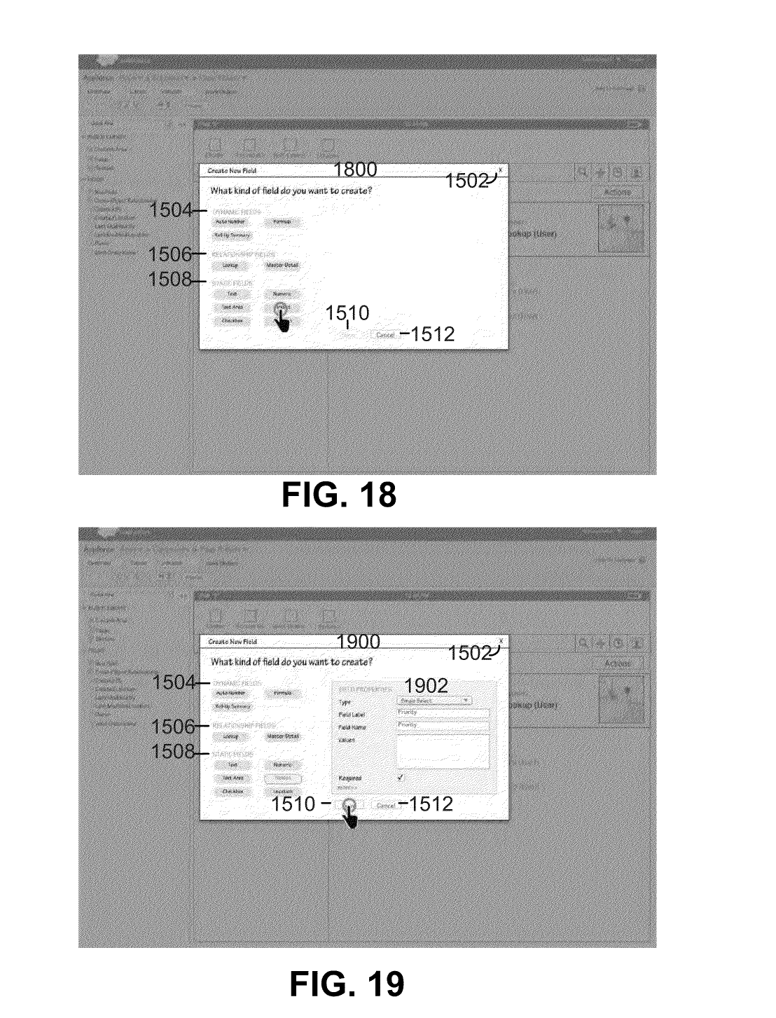

FIG. 18 is a screenshot of an embodiment of create new field page 1800. FIG. 18 and create new field box 1800 are the same as FIG. 15 and create new field box 1500, respectively, except in FIG. 18 a picklist field is selected, whereas in FIG. 15, a text area is selected.

FIG. 19 is a screenshot of an example of interaction 1900 with create new field page 1500 coupled with static field 1508 selection. Interaction 1900 includes close box 1502, dynamic fields 1504, relationship fields 1506, static fields 1508, save tab 1510, close tab 1512, and field properties box 1902. In other embodiments, interaction 1900 may not have all of the elements listed and/or may have other elements instead of, or in addition to, those listed.

Create new field page 1500, close box 1502, dynamic fields 1504, relationship fields 1506, static fields 1508, save tab 1510, and close tab 1512 were explained above in conjunction with FIG. 15.

Interaction 1900 occurs in response to when a user selects the field “picklist” in FIG. 18. In other words, selecting the “picklist” field from create new field page 1800 in FIG. 18 causes interaction 1900 to be rendered and thereby field properties box 1902 is sent to user device 116. Field properties box 1902 may allow users to enter information about the selected field being created. In at least one embodiment of interaction 1900, field properties 1902 specific to user selection of “picklist.” In at least one embodiment, field properties 1902 may include a type of type, a field label, a field name, values, and option to make field required. The type field specifies the type of field. In the current example, the type selected is “single select,” which only allows one selection to be made from the picklist. There may be other types that are available that allow more than one selection to be made from the picklist. Field label is the label that appears next to the picklist informing the user what the picklist is applicable for. Field label is a label assigned to the field, which may also appear next to the picklist. Field name is a name of the field, which may be used elsewhere in the application builder 202, such as in the list of already created fields. The values field is used by the user for entering the values available to the end user in the picklist. If user device 114 enters the values “muffler,” “carburetor,” and “oil change” into the values field, then the resulting picklist, when activated by, the end user (e.g., via user device 116) will offer a choice to the end user to select between “muffler,” “carburetor,” and “oil change.”

Field properties 1902 may also include more detailed properties available through selection of one or more links within field properties box 1902, such as the font of the items in the picklist, or whether the picklist is displayed vertically or horizontally.

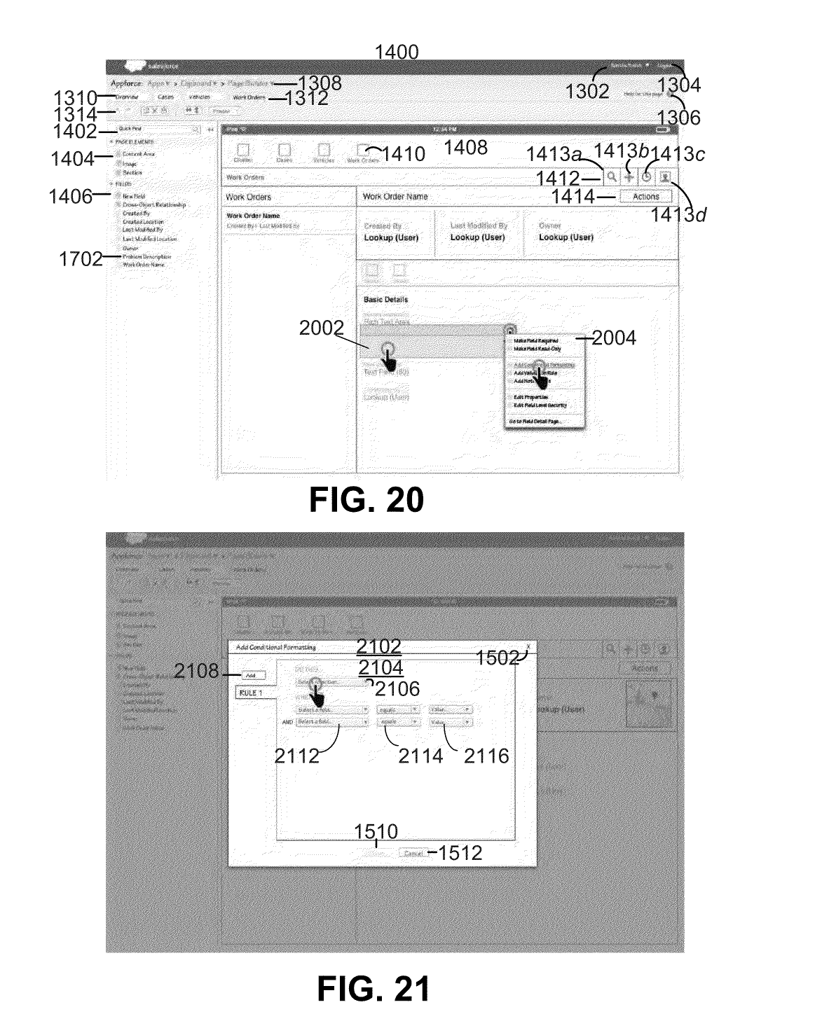

FIG. 20 shows an example of object page 1400 of a website for building applications. Object page 1400 may include user indicator 1302, logout 1304, help 1306, navigation tab 1308, overview tab 1310, object tabs 1312, function bar 1314, page search bar 1402, element list 1404, field list 1406, representative interface 1408, page selector 1410, task bar 1412, task elements 1413a-d, action bar 1414, updated field list 1702, existing field 2002, and field customization box 2004. In other embodiments, object page 1400 may not have all of the elements listed and/or may have other elements instead of, or in addition to, those listed.

User indicator 1302, logout 1304, help 1306, navigation tab 1308, overview tab 1310, object tabs 1312, function bar 1314 were discussed in conjunction with FIG. 13A. Page search bar 1402, element list 1404, field list 1406, representative interface 1408, page selector 1410, task bar 1412, task elements 1413a-d, and action bar 1414 were discussed in conjunction with FIG. 14. Updated field list 1702 was explained in conjunction with FIG. 17.

Existing field 2002 is a field that has already been created. In the example of FIG. 20, existing field 2002 is a rich text area in which the end user enters a description of the problem that needs to be solved (a rich text area is a text area that supports formatted text. Field customization box 2004 may be used to further customize existing fields that have been incorporated into representative interface 1408. Selecting existing field 2002 causes field customization box 2004 to appear. In other words, after the user has made a selection to add a field from field list 1406 to object page 1312, further editing or customization of selected field may be accomplished through user interaction with field customization box 2004. Edit and/or customization options coupled with field customization box may include the option to make field required, make field read only, add conditional formatting, add validation rule, edit properties, edit field level security as well as an option to initiate a process that causes field detail page to be rendered and thereby presented. The conditional formatting is formatting that is applied under certain predefined conditions. If a field is made required, the form cannot be submitted by the end user until the required field is completed. If a validation rule is selected, one or more tests are performed on the text entered. If the test is not successfully passed, an indication is sent to user device 114 that the text that was entered is not acceptable. Edit properties may indicate what type of edits may be made to the text entered. Edit field level security may determine the level of access required of a user to be allowed to edit rich text area. In other embodiments, field customization box 2004 may not have all of the elements listed and/or may have other elements instead of, or in addition to, those listed.

FIG. 21 is a screenshot of an embodiment of conditional formatting page 2102. Conditional formatting page 2102 may include close box 1502, save tab 1510 and close tab 1512, rule box 2104, action 2106, add rule tab 2108, field 2112, operator 2114, and value 2116. In other embodiments, conditional formatting page 2102 may not have all of the elements listed and/or may have other elements instead of, or in addition to, those listed.

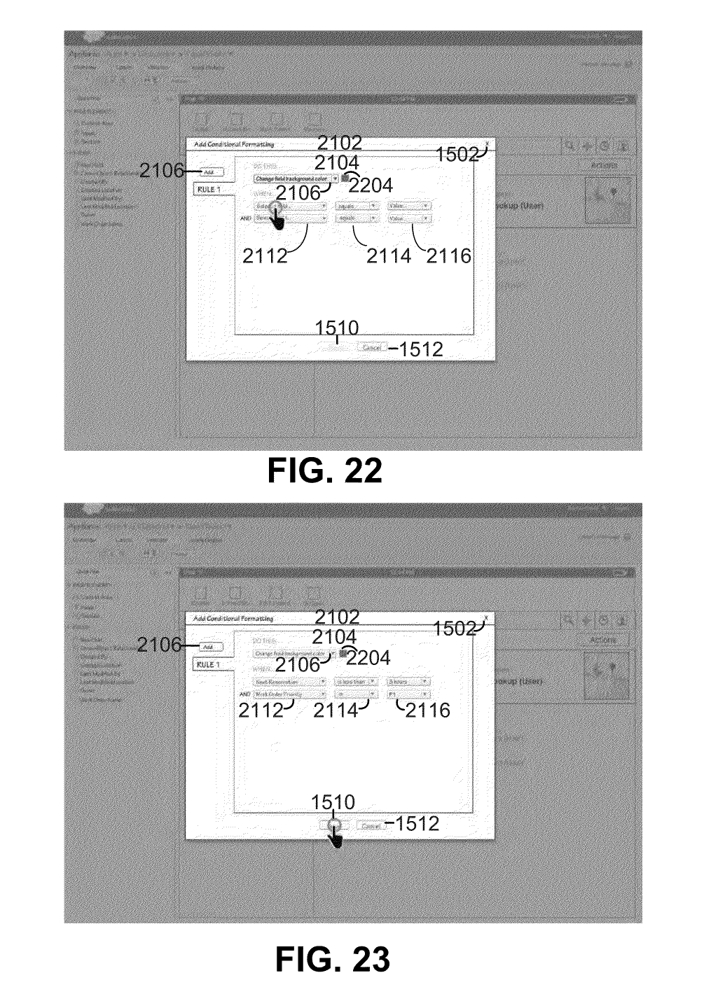

Close box 1502, save tab 1510 and close tab 1512 were explained in conjunction with FIG. 15. Conditional formatting page 2102 is one embodiment of a page for presenting available customization options for customizing a field. Rule box 2104 presents to the user options for constructing a rule. In at least one embodiment, conditional formatting page 2102, when selected, allows users to create one or more rules to define the format of a field based specific criteria. For example, a salesperson may create a rule that is based on the number of units for a particular good he/she has sold in a given month and to display the number of units sold in red if that number is below the quota for that month. Rule box 2104 allows the user to define the rules that define the conditional formatting. In at least one embodiment, rule box 2104 includes dropdown lists that allow a user to select what format changes will occur when two or more fields meet specified requirements. User interaction with rule box 2104 and dropdown lists is discussed in conjunction with FIG. 22 and FIG. 23. Action 2106 allows the user to select an action that will occur when certain conditions are met. Add rule tab 2108 allows the user to add more rules to for the conditional formatting of the rich text field. Field 2112 is a field into which the user enters the name of a field (e.g., via picklist) that needs to meet a certain condition before action 2106 is executed. Operator 2114 is an operator applied to field 2112. Value 2116 is the value that must be met. For example, if action 2106 is change font to uppercase, field 2112 is owner, operator 2116 is equals, and value 2116 is Matt, then whenever the owner of the work order is Matt, the rich text field “problem description” will use uppercase for the font. FIG. 21 illustrates the user selecting a value for action 2106.

FIG. 22 is another screenshot of an embodiment of conditional formatting page 2102. Conditional formatting page 2102 may include close box 1502, save tab 1510 and close tab 1512, rule box 2104, action 2106, add rule tab 2108, field 2112, operator 2114, and value 2116, which were described in FIGS. 15 and 21. Conditional formatting page 2102 may also include color 2204. In other embodiments, conditional formatting page 2102 may not have all of the elements listed and/or may have other elements instead of, or in addition to, those listed.

Color 2204 is the color to which the background will change if the rule of rule box 2104 is met. FIG. 22 is the same as FIG. 21 except now the action 2106 has the value “change field background color.” As result, color 2204 is displayed, which shows the color selected as the background color by action 2106. The user in FIG. 22 is in the process of selecting a value for field 2112.

FIG. 23 is another screenshot of embodiment conditional formatting page 2102. FIG. 23 is the same as FIG. 22, except that values for all of the fields have been selected. Specifically, in the first row, field 2112 has the value “next reservation,” operator 2114 has the value of “less than,” and value 2116 has the value “3 hours,” and in the second row, field 2112 has the value “work order priority,” operator 2114 has the value of “is,” and value 2116 has the value “P1.” As a result, when the field next reservation has a value that is less than 3 hours and when the field priority has a value that is “P1” (which is a high priority), the background of the rich text field, “problem description” is red to alert the user to take care of the work order soon.

FIG. 24 is a screenshot of an embodiment of create new field page 2400 for creating lookup relationship field 1506. FIG. 24 is the same as FIG. 15 except in FIG. 24, a lookup relationship field is selected in order to create a field having a lookup relationship (whereas in FIG. 15 a text field was being created).

FIG. 25 is a screenshot of an example of interaction 2500 with create new field page 1500 coupled with relationship field 1506 selection. Interaction 2500 includes close box 1502, dynamic fields 1504, relationship fields 1506, static fields 1508, save tab 1510, close tab 1512 and field properties box 2502. Create new field page 1500, close box 1502, dynamic fields 1504, relationship fields 1506, static fields 1508, save tab 1510 and close tab 1512 were explained above in conjunction with FIG. 15. In other embodiments, interaction 2500 may not have all of the elements listed and/or may have other elements instead of, or in addition to, those listed.

Interaction 2500 occurs when user selects an option create is “lookup” field to an object. In other words, selecting to create a lookup field causes interaction 2500 to be rendered and thereby field properties box 2502 presented. Field properties box 2502 may allow users to enter information about the selected field being created.

FIG. 25 is the same as FIG. 21 and field properties box 2502 is the same as field properties box 1902, except in FIG. 19 a picklist field was being created while in FIG. 25 a lookup field is being created and field properties box 2502 is for setting the properties of a lookup field, while field properties box 1902 is for creating properties of a picklist field. In an embodiment, the user enters a location where the lookup values may be looked up or enters the actual values to lookup in the values field of field property box 2502. In the example of FIG. 25, the field name and the field label is “vehicle,” and the lookup values may be “makes of cars.”

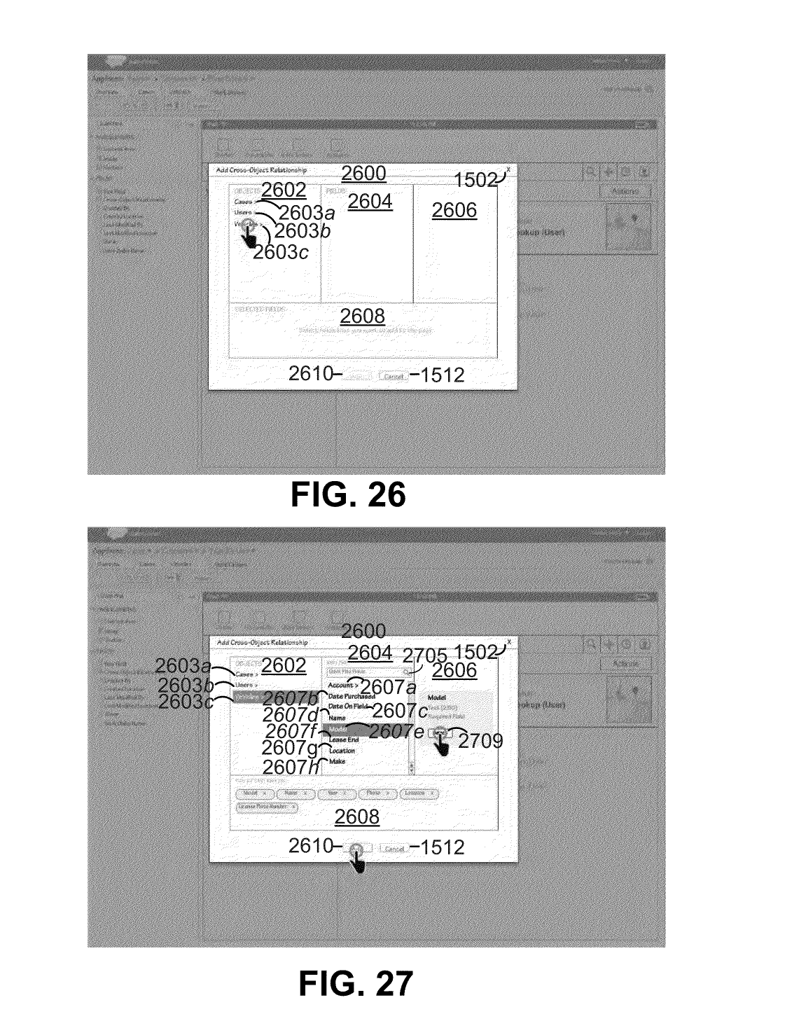

FIG. 26 is a screenshot of an embodiment of add cross-object relationship page 2600 for creating a cross-object relationship between two objects. Add cross-object relationship page 2600 may include close box 1502, close tab 1512, object list 2602, objects 2603a-c, field list 2604, field property list 2606, selected field list 2608, and add 2610. In other embodiments, add cross-object relationship page 2600 may not have all of the elements listed and/or may have other elements instead of, or in addition to, those listed.

Close box 1502 and close tab 1512 were explained in conjunction with FIG. 15. Cross-object relationship page 2600 is a page for establishing a relationship between two objects. In response to receiving a selection of the cross-object relationship box from field list 1406, cross-object relationship page 2600 is sent to user device 114. Object list 2602 displays the one or more objects that were already created or imported in the application being generated. Objects 2603a-c are the object of object list 2602, which were already created. Field list 2604 presents the one or more fields coupled to the object selected 2603c in object list 2602. Field property list 2606 lists the one or more properties coupled to the field or fields selected in field list 2604. In other words, any field selected and/or created, through the processes discussed above, specific to an object are presented in field list 2604 when the specific object is selected in object list 2602. For example, when “vehicles” 2603c is selected, all fields associated with “vehicles” are presented.

Selected field tab 2608 displays fields selected. Add 2610 causes cross-object relationships to be created and incorporated. The result of user selection of “vehicles” 2603c is explained in conjunction with FIG. 27.

FIG. 27 shows another screenshot of an embodiment of add cross-object relationship page 2700, presenting the result of “vehicles” 2603c selection discussed in conjunction with FIG. 26. Add cross-object relationship page 2600 may include close box 1502, close tab 1512, object list 2602, objects 2603a-c, field list 2604, field property list 2606, available fields 2607a-h, selected field list 2608, select 309 and add 2610. Add cross-object relationship page 2700 also includes search box 2705 and select 2709. In other embodiments, add cross-object relationship page 2700 may not have all of the elements listed and/or may have other elements instead of, or in addition to, those listed.

Close box 1502 and close tab 1512 were explained in conjunction with FIG. 15. Object list 2602, objects 2603a-c, field list 2604, field property list 2606, selected field list 2608 and add 2610 were explained in conjunction with FIG. 26.

Search box 2705 includes one or more links and/or fields that allow a user to formulate a search query. As a result of interacting with the search box 2705, a search may be conducted for fields meeting the search query that are coupled to the object 2603a-c selected in object list 2602. For example, interacting with the search box 2705 allows a user to enter a combination of keywords, which may be used as part of a search query to assist user in finding the desired field. Selected fields box 2608 lists the fields that have been selected. Select 2709 is a tab, which when depressed, selects the highlighted field causing the field to be added to selected fields box 2608. Select 2709 initiates a process that results in the addition of the selected field to field box 2608. In at least one embodiment, select 2709 removes the information displayed in field list 2604 and field property list 2606 thereby enables user to begin the process of adding additional fields to be included within cross-object relationship entry.

In at least one embodiment, users may interact with available fields 2607a-h, thereby initiating a process that causes properties specific of a selected field of fields 2607b-h to be displayed. For example, interacting with field “account” 2607a results in “account” properties being presented. The “account” properties may include date purchase, date on field, name, model, lease end, location, and make.

FIG. 28 shows a screenshot of an embodiment of action bar interaction 2800 coupled to object page 1400. Action bar interaction 2800 may include object page 1400, user indicator 1302, logout 1304, help 1306, navigation tab 1308, overview tab 1310, object tabs 1312, function bar 1314, page search bar 1402, element list 1404, field list 1406, representative interface 1408, page selector 1410, task bar 1412, task elements 1413a-d, action bar 1414 (not visible), work order name box 2801, basic details box 2802, vehicle information box 2803, action settings link 2804, and action option box 2805. In other embodiments, interaction 2800 may not have all of the elements listed and/or may have other elements instead of, or in addition to, those listed.

User indicator 1302, logout 1304, help 1306, navigation tab 1308, overview tab 1310, object tabs 1312 and function bar 1314 were explained above in conjunction with FIG. 13A; object page 1400, page search bar 1402, element list 1404, field list 1406, representative interface 1408, page selector 1410, task bar 1412, task elements 1413a-d, action bar 1414 were explained above in conjunction with FIG. 16.

Work order name box 2801 is a field that the user added to object page 1400, which provides an overview of general information pertaining to the work order in question. In at least one embodiment, this information could include vehicle type, date and time of the next reservation, and/or location of the vehicle. Basic details box 2802 is a field that the user added to object page 1400, which provides more specific information pertaining to the work order in name box 2801. The user has added fields object page 1400 that include a problem description, priority number, work order number, assignment to the user, case number, status, and/or date and time of the next reservation.

Vehicle information box 2803 is a field that the user added to object page 1400, which provides information pertaining to the vehicle that is the subject of the work order. In the example of FIG. 28, the fields that the user added to object page 1400 include a license plate number, make, year, and/or model.

Action setting link 2804, when selected, causes action option box 2805 to be sent to the user device 114. In other words, action setting link 2804 provides a user with access to action settings, thereby enabling a user the ability to create new actions, edit existing actions and/or edit page flows by selecting the respective link contained in action option box.

Action option box 2805 includes a choice of links, which when selected, bring the user to a page for modifying actions. For example, the links in action option box may include edit and action, create an action, and edit page flows. A page flow is a sequence of pages that follow or “flow” one another in which when the user is finished interacting with one page the next page in the sequence is presented. The edit page flow link brings the user to a page in which the user can modify and/or create the sequence of pages that makes up a page flow.

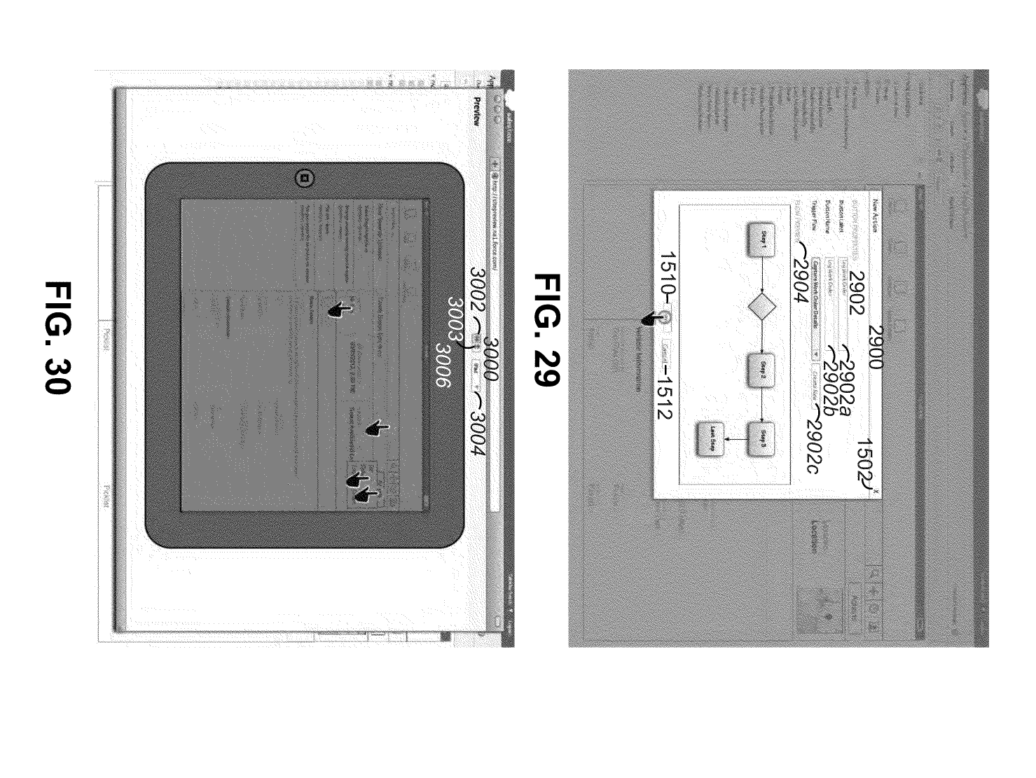

FIG. 29 shows a screenshot of an embodiment of a new action page 2900. New action page 2900 may include close box 1502, save tab 1510, close tab 1512, button properties 2902, button property fields 2902a-c and flow preview 2904. In other embodiments, new action page 2900 may not have all of the elements listed and/or may have other elements instead of, or in addition to, those listed.

Close box 1502 and save tab 1510 were explained above in conjunction with FIG. 15.

New action page 2900 is a page that initiates adding actions to an object page 1312. Actions perform a sequence of actions, which may be determined by a set of logic rules, which may involve navigating to different locations in the application when a page event occurs. For example, action page 2900 allows a user to add an action to the webpage. In at least one embodiment, new action page 2900 allows a user to create a selectable action that is presented to a user when he/she selects and/or hovers over action bar 1414. Button properties 2902 is a set of fields into which the user enters information that characterize and/or define the action being created. Button properties 2902 allow a user to enter unique information related to the action being created in new action page 2900. For example, if user creates an action to display user information, user may wish to provide the action with a name and/or title that will allow recognition of the actions function. Button properties 2902 provide the user this ability. Button properties 2902 may include button label 2902a, button name 2902b, and trigger flow 2902c. Button label 2902a is a field into which a user enters an identifier, which will be displayed when user interacts with action bar 1414. Button name 2902b is a field into which a user enters an identifier to be associated with the action, which will be displayed within application builder 202 to identify the action. In at least one embodiment, selecting action setting link 2802 (FIG. 28) causes action option box 2804 (FIG. 28) to be presented thereby allowing user the ability to select edit existing action link which will initiate a process that allows a user to select and edit an existing action which is recognizable to user by button name 2902b entry.

Trigger flow 2902c is a field that the user selects to determine the sequence of tasks that make up the action. Trigger flow 2902c allows a user the ability to determine the order in which actions take place. Interacting with trigger flow 2902c enables a user to assign an action to the button properties entered above. In at least one embodiment, trigger flow 2902c actions may include navigating the user from field to field that need to be filled in. For example, a manager may generate an application including an action that walks the end user through the process of filling out a work order. Trigger flow 2904 provides manager the ability to control the order of tasks that make up an action execute. In the example of FIG. 29, trigger flow 2904 is set to capture work order details, which may be asset of actions that request the user to fill out details of the work order flow preview 2904 provides a user with a visual representation of process initiated by the action button, which may be associated with any particular set of button properties 2902.

FIG. 30 shows a screenshot of an example action preview page 3000 of website for building applications. Preview page 3000 may include action tab 3002, flow tab 3003, device tab 3004 and device preview 3006. In other embodiments, preview page 3000 may not have all of the elements listed and/or may have other elements instead of, or in addition to, those listed.

Action preview page 3000 provides user the ability to observe, how actions will look and/or perform on any number of user devices 4212, thereby enabling the ability to discover errors within an application before completion. Selecting action tab 3002 causes a different action associated with a specific object page 1312 (FIG. 13A) to be rendered on user device 114 within action preview page 3000. Selecting flow tab 3003 causes the next step in action specific flow to be rendered within action preview page 3000. In other words, action preview page 3000 presents user with the sequence of steps of an action. Subsequent steps specific to an action can be presented by selecting flow tab 3003. Device tab 3004 allows a user to visualize how actions will look and/or perform across various user devices. For example, selecting device tab 3004 may result in a drop-down list being presented to user, where the drop-down list has devices capable of running the application being generated. Selecting a specific device may cause a new action preview page to be rendered on user device 114 that is specific to the selected device, thereby presenting user with a view of how the actions will look and/or perform on selected device.

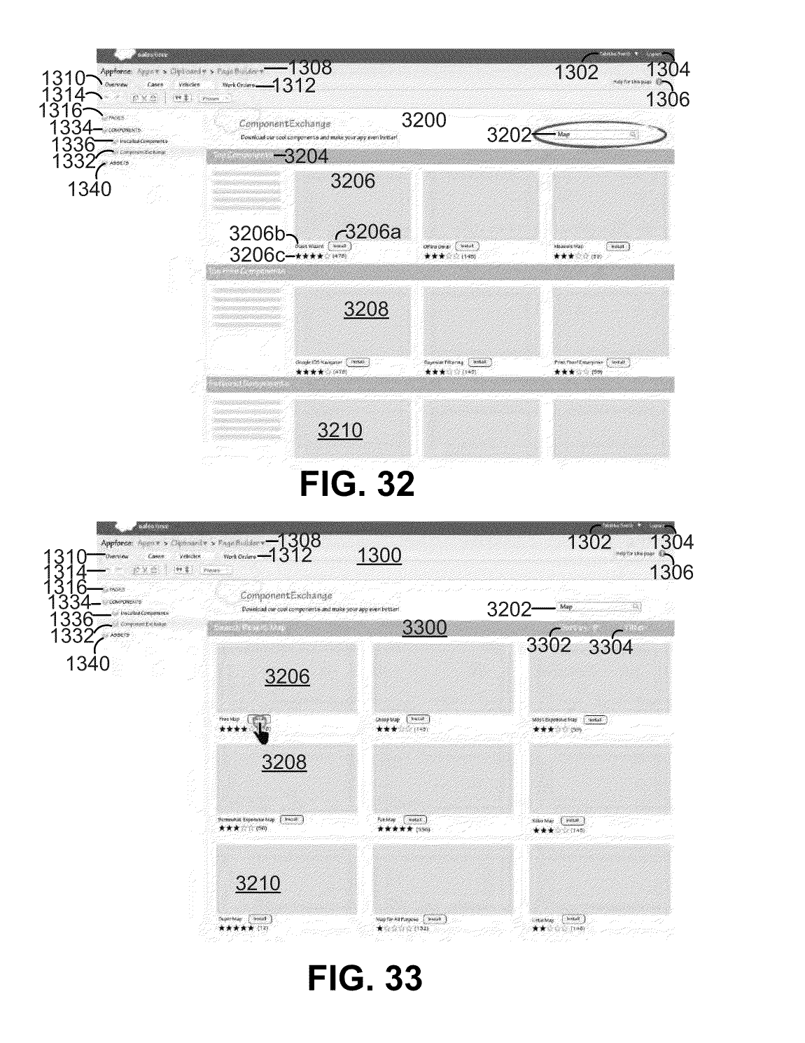

FIG. 31 is the same as FIG. 13A, except that in FIG. 31 component exchange 1338 is selected. The component exchange webpage is further explained in conjunction with FIG. 32.

FIG. 32 shows a screenshot of an example of a component exchange page 3200. Component exchange page 3200 may include user indicator 1302, logout 1304, help 1306, navigation tab 1308, overview tab 1310, object tabs 1312, function bar 1314, overview selection 1316 and component list 1334 including installed components 1336, and component exchange 1338. Component exchange page 3200 may also include component search bar 3202, top component box 3204, component tile 3206 containing install tab 3206a, component name 3206b, component rating 3206c, top free component box 3208, and featured component box 3210. In other embodiments, component exchange page 3200 may not have all of the elements listed and/or may have other elements instead of, or in addition to, those listed.

User indicator 1302, logout 1304, help 1306, navigation tab 1308, overview tab 1310, object tabs 1312, function bar 1314, overview selection 1316, component list 1334 consisting of installed components 1336 and component exchange 1338 were explained above in conjunction with FIG. 13A.

Component exchange page 3200 displays components that other users have posted, and also displays a variety of types of information that a user may want to interact with when determining whether to install a component. Component search bar 3202, when selected, initiates a search based on a search query. After the search has been initiated, server system 110 sends the webpage to user device 114 in the search result page, as the results of the search to the user. Search result page is discussed below in conjunction with FIG. 33.

Top component box 3204 displays one or more of the most popular components available for installation. In at least one embodiment, the components displayed in top component box 3204 are determined by the popularity of a component. For example, the components displayed in top component box 3204 are the components that have been installed more times than any other component. In another embodiment, the popularity of a component could be based on the number times a component has been incorporated into an application, as opposed to being installed but not incorporated. Additional embodiments may base the popularity of a component on the price paid, the highest ranking, featured, whether the component is free, the number of installations over a specific length of time and/or any combination of factors already discussed and/or other factors instead of, or in addition to, those listed.

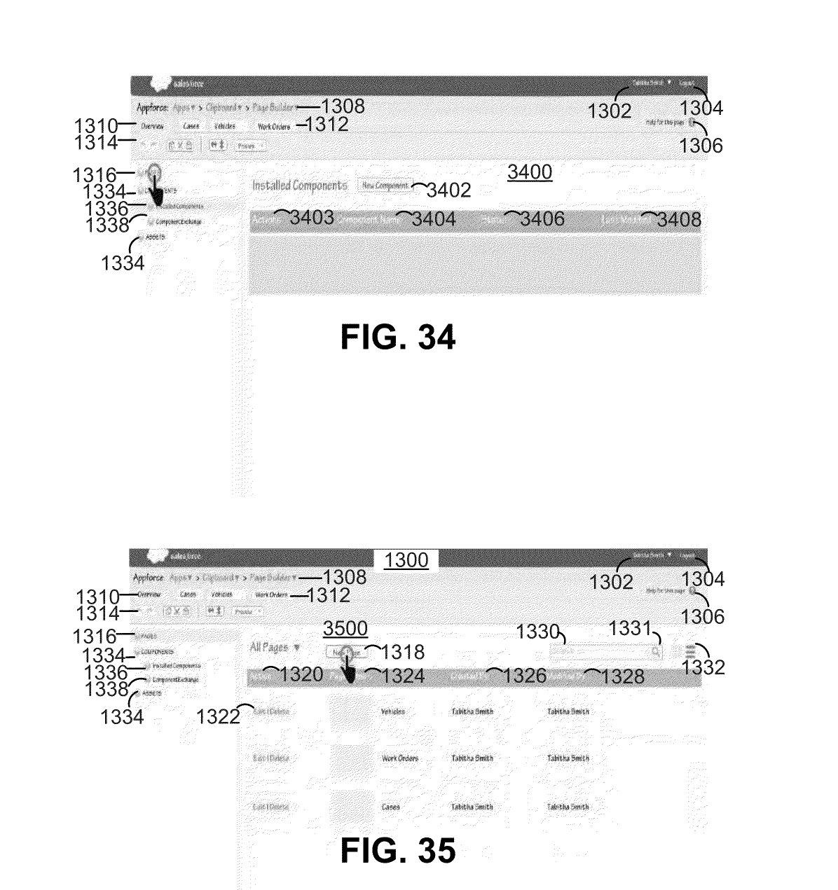

Component tile 3206 displays a variety of types of information that a user may want to use when determining which component to install. In at least one embodiment, component tile may include install tab 3206a, component name 3206b, and component rating 3206c. Selecting install tab 3206a initiates an installation of the component or initiates a process whereby the selected component is stored and subsequently available to a user within installed component page discussed below in conjunction with FIG. 34. Component name 3206b is a unique identifier specific to a particular component. Component rating 3206c displays an average rating given to a particular component, by other users. In at least one embodiment, component rating 3206c is provided in a five star format where users are able to rate a component on a zero to five star scale where zero is the lowest possible rating and five is the highest possible. The average of all user ratings is then combined, averaged and presented to user along with the number of times that component has been rated by users. Top free component box 3208 lists the top components that are free. Featured component box 3210 are components that are featured elsewhere in the website for the component exchanges. In an embodiment, featured components may be sponsored listings.

FIG. 33 shows a screenshot of an example search result page 3300. Search result page 3300 may include user indicator 1302, logout 1304, help 1306, navigation tab 1308, overview tab 1310, object tabs 1312, function bar 1314, overview selection 1316 and component list 1334 consisting of installed components 1336 and component exchange 1338. Search result page 3300 may also include component search bar 3202, component tile 3206, sort tab 3302 and filter tab 3304. In other embodiments, search result page 3300 may not have all of the elements listed and/or may have other elements instead of, or in addition to, those listed.

User indicator 1302, logout 1304, help 1306, navigation tab 1308, overview tab 1310, object tabs 1312, function bar 1314, overview selection 1316 and component list 1334 consisting of installed components 1336 and component exchange 1338 were explained above in conjunction with FIG. 13A. Component search bar 3202 and component tile 3206 were explained above in FIG. 32.

Filter tab 3304 may allow the user to select from a menu of filters that have already been associated with system 200. In at least one embodiment, filters may include component creator, category, subject, location, and/or date created. Sort tab 3302 may allow a user to alter how search results are displayed in search result page 3300. For example, a user may sort the results based on price by selecting to display the results from highest price to lowest price or vice versa. Sort may include price high to low, price low to high, date released newest to oldest, date released oldest to newest, ranting high to low, rating low to high, download number high to low and download number low to high. Filter tab 3304 may allow the user to select from a menu of filters that have already been associated with system 200. In at least one embodiment, filters may include component creator, category, subject, location, and/or date created.

FIG. 34 shows a screenshot of an example installed component page 3400. Installed component page 3400 may include user indicator 1302, logout 1304, help 1306, navigation tab 1308, overview tab 1310, object tabs 1312, function bar 1314, overview selection 1316, and component list 1334 consisting of installed components 1336 and component exchange 1338. Installed component page 3400 may also include new component tab 3402, actions 3403, component name list 3404, status list 3406, and last modified by list 3408. In other embodiments, installed component page 3400 may not have all of the elements listed and/or may have other elements instead of, or in addition to, those listed.

User indicator 1302, logout 1304, help 1306, navigation tab 1308, overview tab 1310, object tabs 1312, function bar 1314, overview selection 1316, actions 1320 and component list 1334 consisting of installed components 1336 and component exchange 1338 were explained above in conjunction with FIG. 13A.

Installed component page 3400 may display the components that are already installed and a variety of information specific to components installed by a user. New component link 3402, when selected, initializes a process of adding a new component to the object, and may allow users to install additional components. When selected, new component tab 3402 causes component exchange page 3200 to be rendered on the user device 114, having an enabling selection of new components. Action 3403 is an action associated with the component listed. The action may be performed by the component, for example. Component name list 3404 displays names of one or more installed components in a list where the component is identified by component name 3206b. Status list 3406 displays the status of the one or more installed components. For example, if user incorporates a map component into page A, status list 3406 may indicate the location of the map component by displaying A. In another embodiment, status list may be left blank if a user has installed a component but not yet assigned the component to a page. Last modified list 3408 associates a name or unique identifier with the user who most recently modified a specific component.

FIG. 35 shows an example new page tab interaction 3500 within application overview page 1300 of a website for building applications. FIG. 35 is the same as FIG. 13A except that in FIG. 35 the user is in the process of selecting new page 1318.

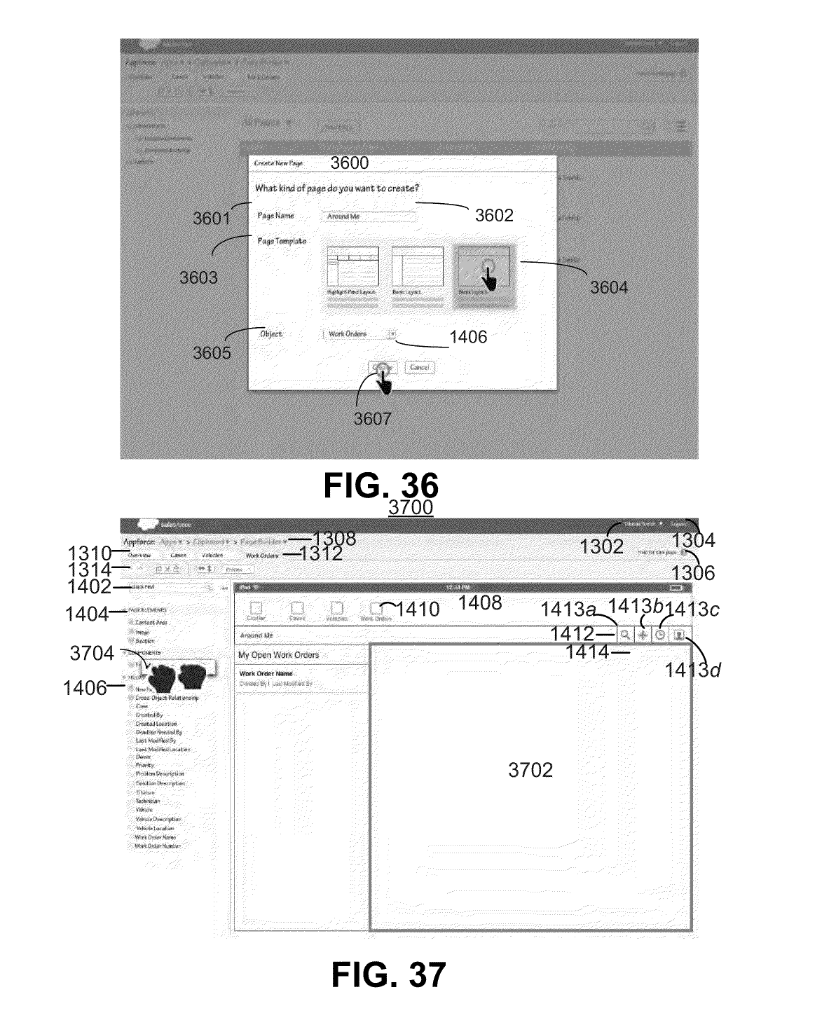

New page tab interaction 3500 causes a new page to be created. Interaction 3500 occurs when new page tab 1318 is selected. When selected, causes the create new page box to be rendered on a user device, thereby allowing the user to import and/or create new objects which will be incorporated as new pages within the overview tab 1310. Create new page box is further explained below in conjunction with FIG. 36. Selecting from one of the options within the navigation field 1316 is discussed in conjunction with FIG. 31.

FIG. 36 shows an example of interface 3600 for creating a new page. Interface 3600 may include page name box 3601 having an input name field 3602, page template box 3603 having template option field 3604, object import box 3605 having object option field 3606, and create page box 3607. In other embodiments, interface 3600 may not have all of the elements listed and/or may have other elements instead of, or in addition to, those listed.

Interface 3600 includes box for creating a new page, which has an expanded set of options for designing applications and import and/or creation objects. Page name box 3601 includes one or more fields into which a user enters the page name. As a result of entering the name into name box 3601, a name will be associated (stored) with the page. For example, input name field 3602 allows a user to enter a combination of letters, symbols, and/or numbers which will be stored with the application and will allow the user to find and interact with the name's page in future embodiments. In at least one embodiment, if no combination of letters, symbols, or numbers is entered, a generic name will be given to the application.

Page template box 3603 allows the user to select from predefined templates for use in page generation. In at least one embodiment, page template box 3603 displays a limited number of available template option fields 3604 from which the user can select. In other words, the user selects a particular layout from template option fields 3604, which determines the template for the new page.

Object import box 3605 allows the user to import a data object into the new page. In other words, object import box 3605 enables the user to import objects for use within the application being generated. In at least one embodiment, the user may select from previously created objects and the data associated with the object will be incorporated within the application being generated. In other embodiments, the user may select from predefined objects, lacking any associated data, and at a later time decide to create data to be associated with the selected object. In other embodiments, object import box 3605 may not have all of the elements listed and/or may have other elements instead of, or in addition to, those listed.

Object import box 3605 is similar to object import box 1104, with the exception that 3605 provides an expandable object option field 1206 that allows the user to select the type of object to import. In other words, upon selecting expandable object option field 1206, additional objects are displayed for the user to select.

Create page box 3607, when selected, brings the user to a object page 1400 that includes links and/or instructions for further customization of the page being generated (the webpage associated with the page overview interface is discussed in conjunction with FIG. 14). In at least one embodiment, the create page box 3607 is enabled after the user enters information into the input name field 3602. In another embodiment, the create page box 3607 is enabled after the user selects a template option field 3604. Alternatively, the create page box 3607 is always enabled allowing the blank page to be found in object page 1400 at a later time.

FIG. 37 shows a screenshot of an example of object page 3700, which is blank. Object page 3700 may include user indicator 1302, logout 1304, help 1306, navigation tab 1308, overview tab 1310, object tabs 1312, function bar 1314, page search bar 1402, element list 1404, field list 1406, representative interface 1408, page selector 1410, task bar 1412, task elements 1413a-d, and action bar 1414 (not visible). Object page 3700 may also include blank region 3702 and new field interaction 3704. In other embodiments, new blank page 3700 may not have all of the elements listed and/or may have other elements instead of, or in addition to, those listed.

User indicator 1302, logout 1304, help 1306, navigation tab 1308, overview tab 1310, object tabs 1312 and function bar 1314 were explained above in conjunction with FIG. 13A; object page 1400, page search bar 1402, element list 1404, field list 1406, representative interface 1408, page selector 1410, task bar 1412, task elements 1413a-d, action bar 1414 were explained above in conjunction with FIG. 16.

Object page 3700 is rendered and displayed on user device 114 as a result of user interaction with interface 3600. Blank region 3702 represents a blank region that is part of object page 3700, which is being added to an object. If nothing further is done, the resulting application will have a blank page that looks like blank region 3702. New field interaction 3704, represents a user selecting (and thereby requesting to add) a new component to blank region 3702. In new field interaction 3704, the user has selected “free component” from the list of components, in order to add the free component to object page 3700.

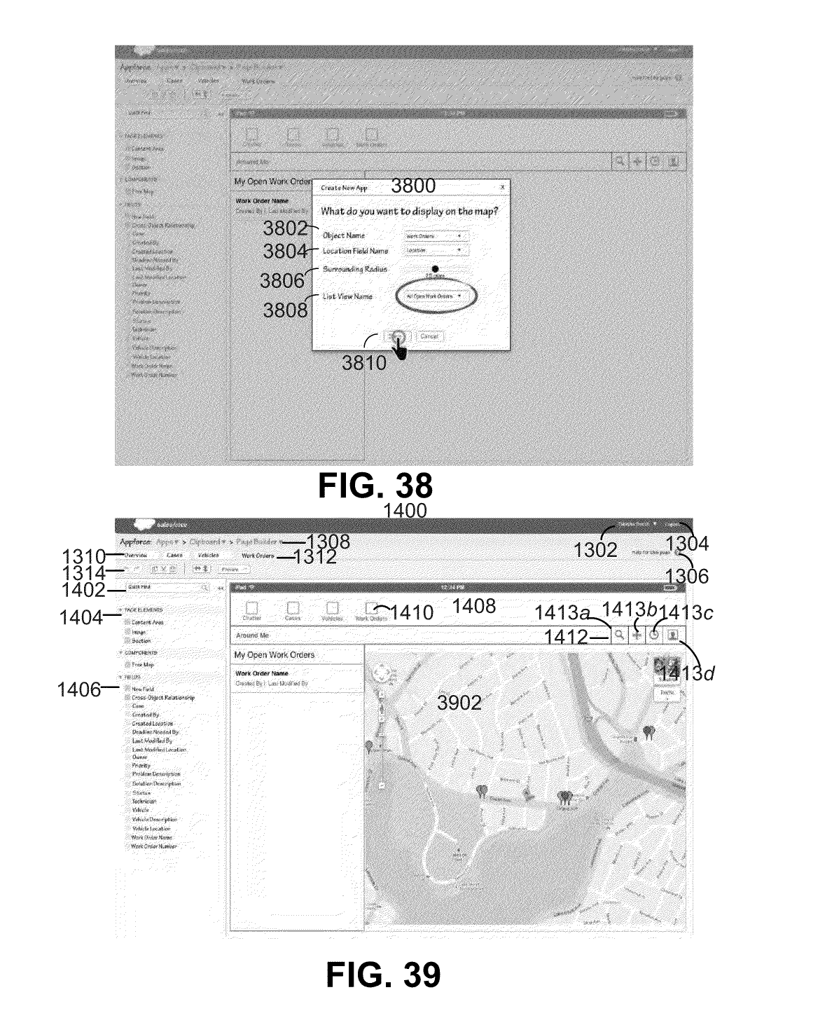

FIG. 38 shows a screenshot of an embodiment of an interaction 3800 that allows user to further customize the work order by generating a map. Interaction 3800 may include object name 3802, location field name 3804, surrounding radius 3806, list view name 3808, and save button 3810. In other embodiments, interaction 3800 may not have the same elements as those listed above and/or may have other elements instead of, or in addition to, those listed above.

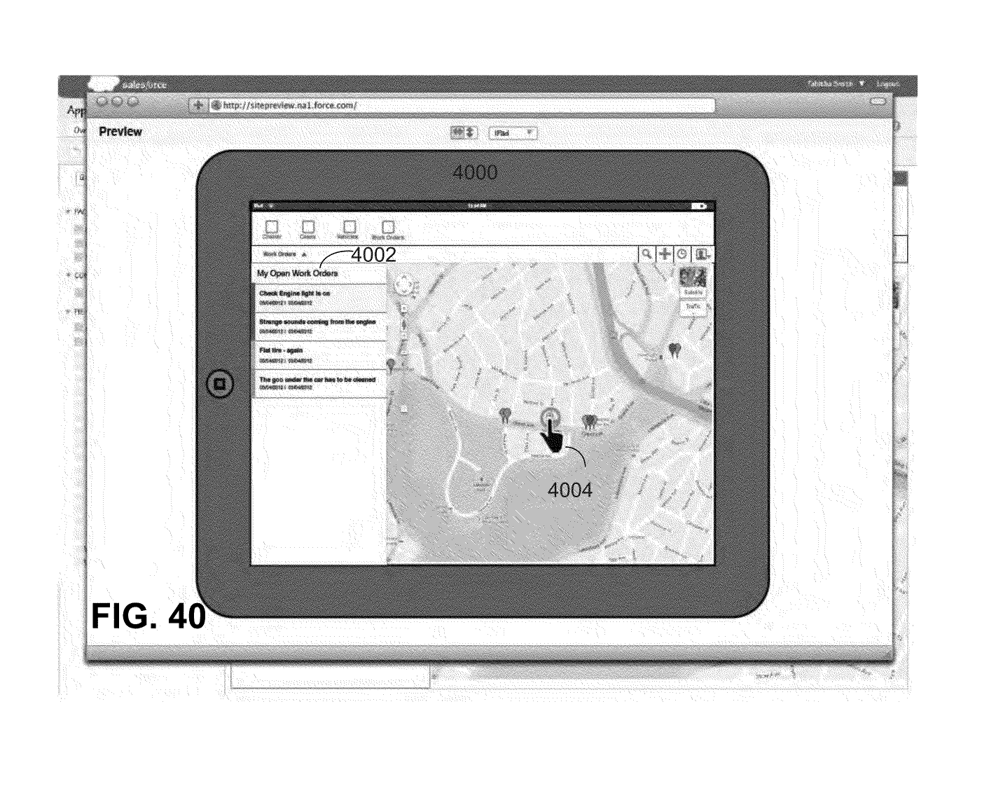

Interaction 3800 adds the free component to the work order application. Although the interface for interaction 3800 is titled create new application, interaction 3800 may be an interface for adding a component to an application. Object page 3700 may be customized via interaction 3800. Object name 3802 provides users with an expandable drop-down menu that, when selected, displays a pre-determined set of names from which user may choose. In at least one embodiment, object name 3802 may be termed “Work Orders.” Location field name 3804 provides user with an expandable drop-down menu that, when selected, displays a pre-determined set of names from which user may choose. In at least one embodiment, the location field name 3804 may be termed “Location.” Surrounding radius 3806 allows users to select a particular distance around the selected location that will be displayed on component 3902. In at least one embodiment, the surrounding radius may be 25 miles. List view name 3808 provides users with an expandable drop-down menu that, when selected, displays a pre-determined set of names from which user may choose. In at least one embodiment, list view name 3808 may be termed “All Open Work Orders.” Save button 3810 applies the customized features selected by user and renders component 3902 further described in conjunction with FIG. 39.

FIG. 39 shows a screenshot of an embodiment of object page 1400 coupled to a newly added component. Object page 1400 may include user indicator 1302, logout 1304, help 1306, navigation tab 1308, overview tab 1310, object tabs 1312, function bar 1314, page search bar 1402, element list 1404, field list 1406, representative interface 1408, page selector 1410, task bar 1412, task elements 1413a-d, and action bar 1414 (not visible). Object page 1400 also includes component 3902. In other embodiments, object page 1400 may not have all of the elements listed and/or may have other elements instead of, or in addition to, those listed.

User indicator 1302, logout 1304, help 1306, navigation tab 1308, overview tab 1310, object tabs 1312 and function bar 1314 were explained above in conjunction with FIG. 13A. Object page 1400, page search bar 1402, element list 1404, field list 1406, representative interface 1408, page selector 1410, task bar 1412, task elements 1413a-d, action bar 1414 were explained above in conjunction with FIG. 16.

Component 3902 is an example of a component that may be added to an object. Although a map is used as an example of component 3902, other types of components may be substituted instead. As result of interaction 3800 (FIG. 38), component 3902 appears in object page 1400.

FIG. 40 shows a screenshot of an embodiment of map preview webpage 4000. Preview webpage 4000 may include the newly added component on a page of an application to which the component was added. In the example of FIG. 40, the preview webpage shows a map on the application page (to which the map was added). Work order list 4002 and work order location 4004. In other embodiments, map preview webpage 4000 may not have all of the elements listed and/or may have other elements instead of, or in addition to, those listed.

Work order list 4002 displays a column of the various work orders with their respective problem descriptions. Work order location 4004 allows user to select a particular work order based on geographic location in order to visualize additional details.

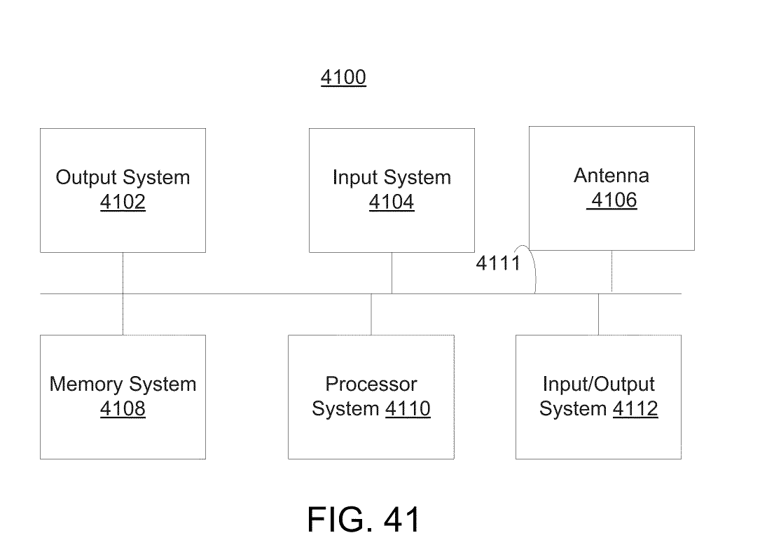

FIG. 41 shows a block diagram of an embodiment of a user device 4100. The mobile device may include output system 4102, input system 4104, antenna 4106, memory system 4108, processor system 4110, and input/output system 4112. In other embodiments, the mobile device illustrated in FIG. 41 may include additional components and/or may not include all of the components listed above.

User device 4100 may be a smart phone, tablet computer, other mobile device, or other user device that uses applications. User device 4100 is one embodiment of user device 116, for example.

Output system 4102 may include any one of, some of, any combination of, or all of a monitor system, a handheld display system, a speaker system, a connection or interface system to a sound system, an interface system to peripheral devices and/or a connection and/or interface system to a mobile device, intranet, and/or internet, for example.

Input system 4104 may include any one of, some of, any combination of, or all of a keyboard system, a track ball system, a track pad system, buttons on a handheld system, a scanner system, a microphone system, a connection to a sound system, and/or a connection and/or interface system to a mobile device, intranet, and/or internet (e.g., IrDA, USB), for example.

Antenna 4106 communicatively links output system 4102, input system 4104, memory system 4108, processor system 4110, and/or input/output system 4112 to each other. Antenna 4106 may include any means of sending signals through air or water via wireless communications. Some examples of means of sending signals through air and/or water include systems for transmitting electromagnetic waves such as infrared and/or radio waves and/or systems for sending sound waves.

Memory system 4108 may include, for example, any one of, some of, any combination of, or all of a long term storage system, such as a hard drive; a short term storage system, such as random access memory; a removable storage system, such as a floppy drive or a removable drive; and/or flash memory. Memory system 4108 may include one or more non-transitory machine-readable media that may store a variety of different types of information. The term non-transitory machine-readable medium is used to refer to any non-transitory medium capable carrying information that is readable by a machine. One example of a machine-readable medium is a computer-readable medium.

Processor system 4110 may include any one of, some of, any combination of, or all of multiple parallel processors, a single processor, a system of processors having one or more central processors and/or one or more specialized processors dedicated to specific tasks.

Input/output system 4112 may include devices that have the dual function as input and output devices. For example, input/output system 4112 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 4112 is optional, and may be used in addition to or in place of output system 4102 and/or input device 4104.

### System Overview

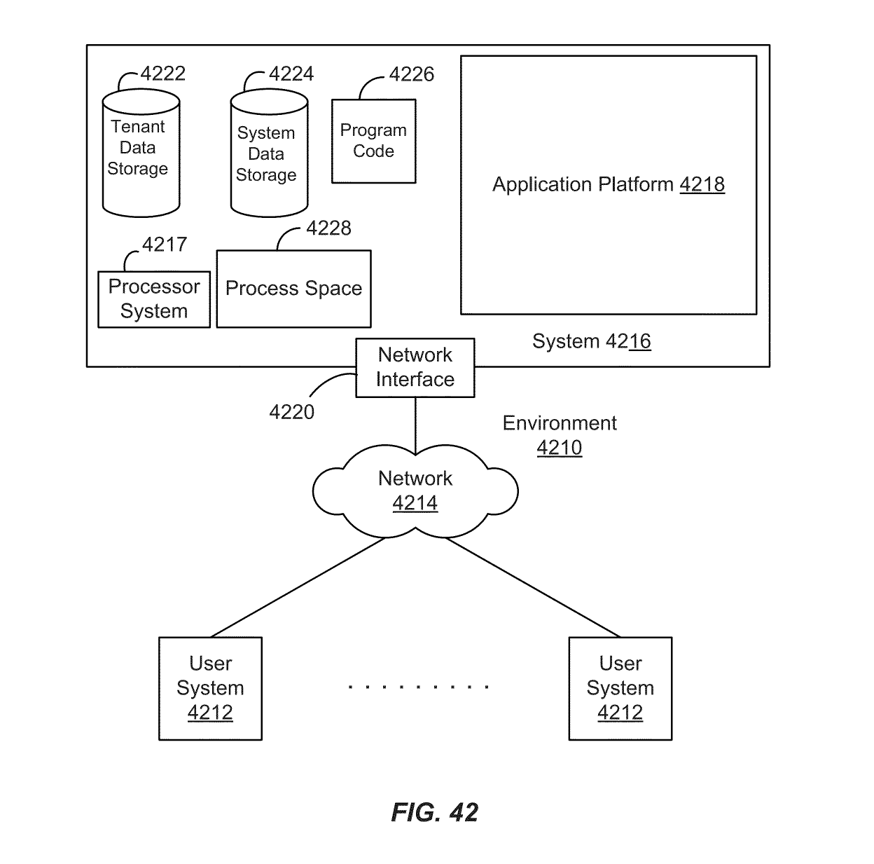

FIG. 42 illustrates a block diagram of an environment 4210 wherein an application generation system coupled to an on-demand database service might be used. Environment 4210 may include user system 4212, network 4214, system 4216, processor system 4217, application platform 4218, network interface 4220, tenant data storage 4222, system data storage 4224, program code 4226, and process space 4228. In other embodiments, environment 4210 may not have all of the components listed and/or may have other elements instead of, or in addition to, those listed above.

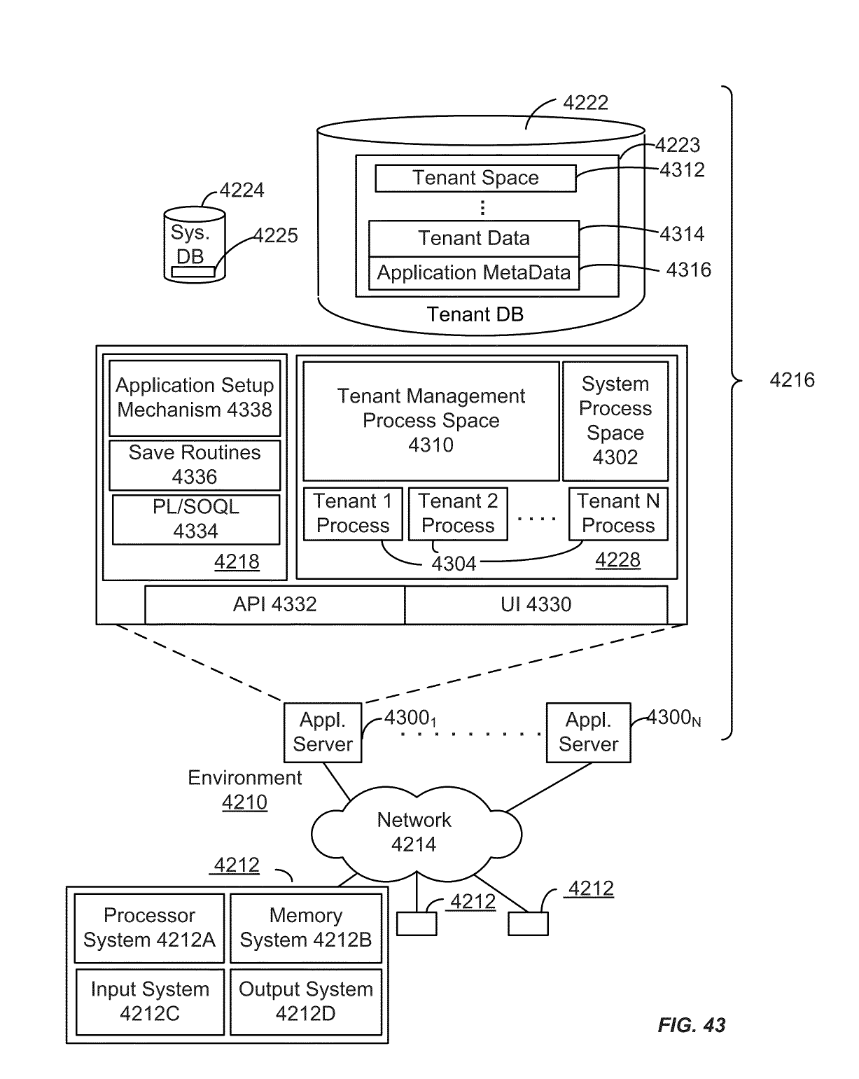

Environment 4210 is an environment in which an on-demand database service exists. User system 4212 may be any machine or system that is used by a user to access a database user system. For example, any of user systems 4212 can be a handheld computing device, a mobile phone, a laptop computer, a work station, and/or a network of computing devices. User devices 114 and 116 are examples of user system 4212. As illustrated in FIG. 42 (and in more detail in FIG. 43) user systems 4212 might interact via a network 4214 with an on-demand database service, which is system 4216. System 4216 is an embodiment of server 110.

An on-demand database service, such as system 4216, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 4216” and “system 4216” will be used interchangeably herein. A database image may include one or more database objects. A relational database management system (RDMS) or the equivalent may execute storage and retrieval of information against the database object(s). Application platform 4218 may be a framework that allows the applications of system 4216 to run, such as the hardware and/or software, e.g., the operating system. In at least one embodiment, on-demand database service 4216 may include an application platform 4218 that enables creation, managing and executing one or more applications developed by the provider of the on-demand database service, users accessing the on-demand database service via user systems 4212, or third party application developers accessing the on-demand database service via user systems 4212.

The users of user system 4212 may differ in their respective capacities, and the capacity of a particular user system 4212 might be entirely determined by permissions (permission levels) for the current user. For example, where a salesperson is using a particular user system 4212 to interact with system 4216, that user system 4212 has the capacities allotted to that salesperson. However, while an administrator is using that user system to interact with system 4216, that user system 4212 has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 4214 is any network or combination of networks of devices that communicate with one another. For example, network 4214 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User system 4212 might communicate with system 4216 using TCP/IP and, at a higher network level, use other common Internet protocols to communicate, such as HTTP, FTP, AFS, WAP, etc. In an example where HTTP is used, user system 4212 might include an HTTP client commonly referred to as a “browser” for sending and receiving HTTP messages to and from an HTTP server at system 4216. Such an HTTP server might be implemented as the sole network interface between system 4216 and network 4214, but other techniques might be used as well or instead. In some implementations, the interface between system 4216 and network 4214 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In at least one embodiment, system 4216, shown in FIG. 43, implements a web-based customer relationship management (CRM) system. For example, in at least one embodiment, system 4216 includes application servers configured to implement and execute CRM software applications as well as provide related data, code, forms, webpages and other information to and from user system 4212 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain at least one embodiment, system 4216 implements applications other than, or in addition to, a CRM application. For example, system 4216 may provide tenant access to multiple hosted (standard and custom) applications, including a CRM application. User (or third party developer) applications, which may or may not include CRM, may be supported by the application platform 4218, which manages creation, storage of the applications into one or more database objects and executing of the applications in a virtual machine in the process space of the system 4216.

One arrangement for elements of system 4216 is shown in FIG. 42, including a network interface 4220, application platform 4218, tenant data storage 4222 for tenant data 4223, system data storage 4224 for system database 4225 accessible to system 4216 and possibly multiple tenants, program code 4226 for implementing various functions of system 4216, and a process space 4228 for executing MTS system processes and tenant-specific processes, such as running applications as part of an application hosting service. Additional processes that may execute on system 4216 include database indexing processes.

Several elements in the system shown in FIG. 43 include conventional, well-known elements that are explained only briefly here. For example, each user system 4212 could include a desktop personal computer, workstation, laptop, PDA, cell phone, or any wireless access protocol (WAP) enabled device or any other computing device capable of interfacing directly or indirectly to the Internet or other network connection. User system 4212 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 4212 to access, process and view information, pages and applications available to it from system 4216 over network 4214. Each user system 4212 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 4216 or other systems or servers. For example, the user interface device can be used to access data and applications hosted by system 4216, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 4212 and all of its components are operator configurable using applications, such as a browser, including computer code run using a central processing unit such as an Intel Pentium® processor or the like. Similarly, system 4216 (and additional instances of an MTS, where more than one is present) and all of their components might be operator configurable using application(s) including computer code to run using a central processing unit such as processor system 4217, which may include an Intel Pentium® processor or the like, and/or multiple processor units. A computer program product embodiment includes a non-transitory machine-readable storage medium (media) having instructions stored thereon/in which can be used to program a computer to perform any of the processes of the embodiments described herein. Computer code for operating and configuring system 4216 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 4216 is configured to provide webpages, forms, applications, data and media content to user (client) systems 4212 to support the access by user systems 4212 as tenants of system 4216. As such, system 4216 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 43 also illustrates environment 4210. However, in FIG. 43 elements of system 4216 and various interconnections in at least one embodiment are further illustrated. FIG. 43 shows that user system 4212 may include processor system 4212A, memory system 4212B, input system 4212C, and output system 4212D. FIG. 43 shows network 4214, system 4216, and system data storage 4224. FIG. 43 also shows that system 4216 may include tenant data storage 4222, applications servers 4300₁-4300_{N}, system process space 4302, tenant process spaces 4304, tenant management process space 4310, tenant space 4312, tenant data 4314, application metadata 4316, tenant data 4314, system database 4225, User Interface (UI) 4330, Application Program Interface (API) 4332, PL/SOQL 4334, save routines 4336, and application setup mechanism 4338. In other embodiments, environment 4210 may not have the same elements as those listed above and/or may have other elements instead of, or in addition to, those listed above.

User system 4212, network 4214, system 4216, tenant data storage 4222, and system data storage 4224 were discussed above in FIG. 42. Regarding user system 4212, processor system 4212A may be any combination of one or more processors. Memory system 4212B may be any combination of one or more memory devices, short term, and/or long term memory. Input system 4212C may be any combination of input devices, such as one or more keyboards, mice, trackballs, scanners, cameras, and/or interfaces to networks. Output system 4212D may be any combination of output devices, such as one or more monitors, printers, and/or interfaces to networks. As shown by FIG. 43, system 4216 may include a network interface 4220 (of FIG. 42) implemented as a set of HTTP application servers 4300, an application platform 4218, tenant data storage 4222, and system data storage 4224. Also shown is system process space 4302, including individual tenant process spaces 4304 and a tenant management process space 4310. Each application server 4300 may be configured to tenant data storage 4222 and the tenant data 4314 therein, and system data storage 4224 and the system database 4225 therein to serve requests of user systems 4212. The tenant data 4314 might be divided into individual tenant space 4312, which can be either a physical arrangement and/or a logical arrangement of data. Within each tenant space 4312, tenant data 4314 and application metadata 4216 might be similarly allocated for each user. For example, a copy of a user's most recently used (MRU) items might be stored to tenant data 4314. Similarly, a copy of MRU items for an entire organization that is a tenant might be stored to tenant space 4312. A UI 4330 provides a user interface and an API 4332 provides an application programmer interface to system 4216 resident processes to users and/or developers at user system 4212. The tenant data and the system data may be stored in various databases, such as one or more Oracle™ databases.

Application platform 4218 includes an application setup mechanism 4338 that supports application developers' creation and management of applications, which may be saved as metadata into tenant data storage 4222 by save routines 4336 for execution by subscribers as one or more tenant process spaces 4304 managed by tenant management process space 4310 for example. Invocations to such applications may be coded using PL/SOQL 4334 that provides a programming language style interface extension to API 4332. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 4216 for the subscriber making the invocation and executing the metadata as an application in a virtual machine.

Each application server 4300 may be communicably coupled to database systems, e.g., having access to system database 4225 and tenant data 4314, via a different network connection. For example, one application server 4300₁ might be coupled via the network 4214 (e.g., the Internet), another application server 4300_{N-1} might be coupled via a direct network link, and another application server 4300_{N} might be coupled by yet a different network connection. Transfer Control Protocol and Internet Protocol (TCP/IP) are typical protocols for communicating between application server 4300 and the database system. However, it will be apparent to one skilled in the art that other transport protocols may be used to optimize the system depending on the network interconnect used.

In certain at least one embodiment, each application server 4300 is configured to handle requests for any user associated with any organization that is a tenant. Because it is desirable to be able to add and remove application servers from the server pool at any time for any reason, there is preferably no server affinity for a user and/or organization to a specific application server 4300. In at least one embodiment, therefore, an interface system implementing a load balancing function (e.g., an F5 Big-IP load balancer) is communicably coupled between the application servers 4300 and the user systems 4212 to distribute requests to the application server 4300. In at least one embodiment, the load balancer uses a least connections algorithm to route user requests to the application server 4300. Other examples of load balancing algorithms, such as round robin and observed response time, also can be used. For example, in certain at least one embodiment, three consecutive requests from the same user could hit three different application servers 4300, and three requests from different users could hit the same application server 4300. In this manner, system 4216 is multi-tenant, wherein system 4216 handles storage of, and access to, different objects, data and applications across disparate users and organizations.

As an example of storage, one tenant might be a company that employs a sales force where each salesperson uses system 4216 to manage their sales process. Thus, a user might maintain contact data, leads data, customer follow-up data, performance data, goals and progress data, etc., all applicable to that user's personal sales process (e.g., in tenant data storage 4222). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 4216 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 4216 might also maintain system level data usable by multiple tenants or other data. Such system level data might include industry reports, news, postings, and the like that are sharable among tenants.

In certain at least one embodiment, user systems 4212 (which may be client systems) communicate with application servers 4300 to request and update system-level and tenant-level data from system 4216 that may require sending one or more queries to tenant data storage 4222 and/or system data storage 4224. System 4216 (e.g., an application server 4300 in system 4216) automatically generates one or more SQL statements (e.g., one or more SQL queries) that are designed to access the desired information. System data storage 4224 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain at least one embodiment, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

### Method for Using the Environment (FIGS. 42 and 43)

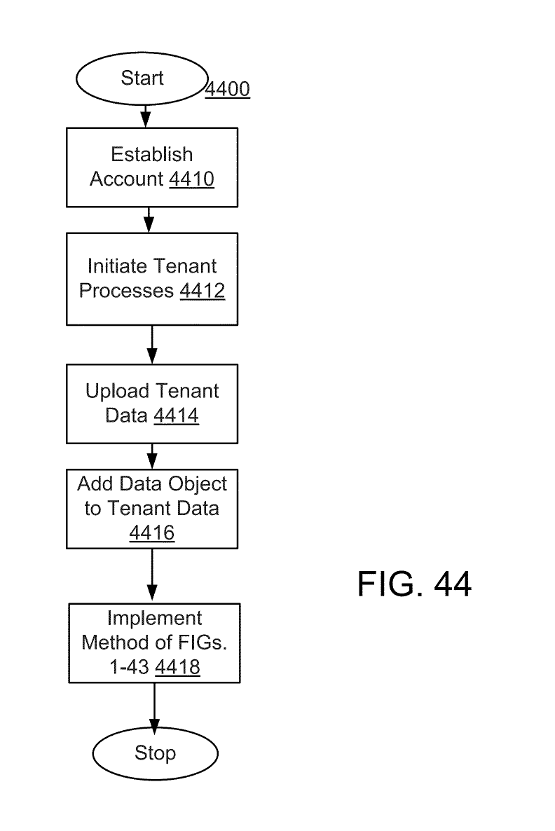

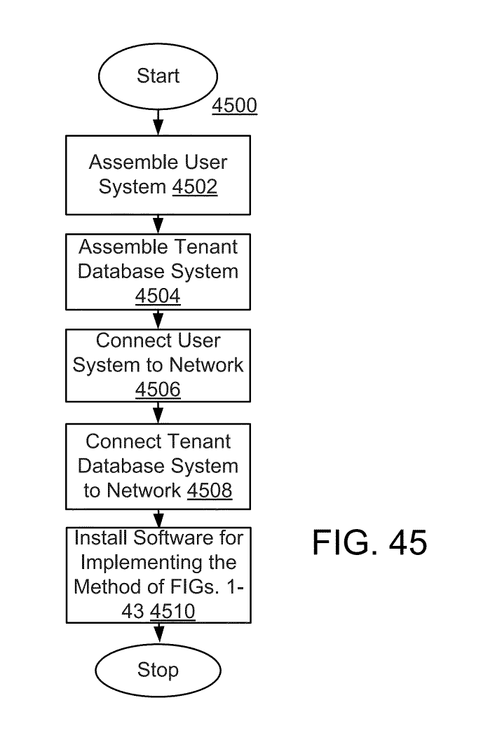

FIG. 44 shows a flowchart of an example of a method 4400 of using environment 4310. In step 4410, user system 4212 (FIGS. 42 and 43) establishes an account. In step 4412, one or more tenant process space 4304 (FIG. 43) are initiated on behalf of user system 4212, which may also involve setting aside space in tenant space 4212 (FIG. 43) and tenant data 4214 (FIG. 43) for user system 4212. Step 4414 may also involve modifying application metadata to accommodate user system 4212. In step 4416, user system 4212 uploads data. In step 4418 one or more data objects are added to tenant data 4214 where the data uploaded is stored. In step 4418, the methods associated with FIGS. 1-9 may be implemented. In another embodiment, although depicted as distinct steps in FIG. 44, steps 4410-4418 may not be distinct steps. In other embodiments, method 4400 may not have all of the above steps and/or may have other steps in addition to, or instead of, those listed above. The steps of method 4400 may be performed in another order. Subsets of the steps listed above as part of method 4400 may be used to form their own method.

### Method for Creating the Environment (FIGS. 42 and 43)

FIG. 45 is a method of making environment 4210. In step 4502, user system 4212 (FIGS. 42 and 43) is assembled, which may include communicatively coupling one or more processors, one or more memory devices, one or more input devices (e.g., one or more mice, keyboards, and/or scanners), one or more output devices (e.g., one more printers, one or more interfaces to networks, and/or one or more monitors) to one another.

In step 4504, system 4216 (FIGS. 42 and 43) is assembled, which may include communicatively coupling one or more processors, one or more memory devices, one or more input devices (e.g., one or more mice, keyboards, and/or scanners), one or more output devices (e.g., one more printers, one or more interfaces to networks, and/or one or more monitors) to one another. Additionally assembling system 4216 may include installing application platform 4218, network interface 4220, tenant data storage 4222, system data storage 4224, system data 4225, program code 4226, process space 4228, UI 4330, API 4232, PL/SOQL 4334, save routines 4336, application setup mechanism 4338, applications servers 4300₁-4300_{N}, system process space 4302, tenant process spaces 4304, tenant management process space 4310, tenant space 4312, tenant data 4314, and application metadata 4316 (FIG. 43).

In step 4506, user system 4212 is communicatively coupled to network 4214. In step 4508, system 4216 is communicatively coupled to network 4214 allowing user system 4212 and system 4216 to communicate with one another (FIG. 42). In step 4510, one or more instructions may be installed in system 4216 (e.g., the instructions may be installed on one or more machine readable media, such as computer readable media, therein) and/or system 4216 is otherwise configured for performing the steps of methods associated with FIGS. 1-9. In at least one embodiment, each of the steps of method 4500 is a distinct step. In another embodiment, although depicted as distinct steps in FIG. 45, steps 4502-4510 may not be distinct steps. In other embodiments, method 4500 may not have all of the above steps and/or may have other steps in addition to, or instead of, those listed above. The steps of method 4500 may be performed in another order. Subsets of the steps listed above as part of method 4500 may be used to form their own method.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A method comprising:
sending, from a host system to a user system, information, which when consumed by the user system, causes a page to be displayed on the user system having features to place in an application, the host system including a processor system having at least one processor and a memory system;
in response, receiving at the host system from the user system, a selection of at least one feature to place in the application;
generating, by the processor system, the application based on the selection of the at least one feature that was received; and
sending the application, from the host system to the user system.

2. The method of claim 1, further comprising: sending, from the host system, information which, when consumed by the user system, causes the use system to display page having selectable templates of applications.

3. The method of claim 2, further comprising: receiving at the host system a selection of one of the selectable templates.

4. The method of claim 1, further comprising: receiving a request to add an object to the application, and in response sending an interface requesting information about the object.

5. The method of claim 1, further comprising: receiving a request to add a field to an object of the application, and in response sending an interface requesting information about the field.

6. The method of claim 5, further comprising: associating with the field instructions to send a request to multi-tenant database to retrieve information from an object of an online multi-tenant database

7. The method of claim 5, the field being a picklist.

8. The method of claim 5, the field being a text field.

9. The method of claim 5, the field being a lookup field.

10. The method of claim 5, the field being a rollup-summary field that displays a value representing an aggregate of other values.

11. The method of claim 8, the method further comprising: associating with the lookup field instructions to send a request to multi-tenant database to lookup information in an object of the multitenant database.

12. The method of claim 5, the field being a master-detail field, where the upon receiving an entry in a master object, related details are retrieved from a detail object and displayed in the application.

13. The method of claim 5, receiving a request to add a component to the application, and in response sending a view of a list of components posted on a component exchange.

14. The method of claim 1, further comprising sending a list of selectable applications and an association of application with a status of the application.

15. The method of claim 1, further comprising sending a list of selectable objects of an application to the user machine.

16. The method of claim 1, further comprising: receiving a request to add conditional formatting to a field, and in response sending an interface having fields for entering the formatting desired and a rule that determines whether to apply the formatting.

17. The method of claim 1, the interface having a picklist of formats, a picklist of fields and picklists of operators and field for entering a value, the operator determining whether the condition is met based on the value entered and the field chosen.

18. A host system comprising:
a processor system having one or more processors; and
a memory system communicatively coupled to the processor system, the memory system storing one or more machine instructions, which when implemented cause, the system to implement a method including at least:
sending, from the host system to a user system, information for rendering one or more webpages to the user system, the one or more webpages including instructions and tools for building an application, the tools being active page elements, which when selected, cause a request to be sent to the host system;
in response, receiving at the host system from the user system, a selection of features to place in the application;
generating, by the processor system, the application based on the selection of features received; and
sending the application, from the host system to the user system.

19. A non-transitory computer-readable medium having one or more machine instructions stored thereon, which when implemented causes a method to be implemented, the method comprising:
sending, from the host system to a user system, information to the user system, information when consumed by the user system, causes a page to be displayed on the user system having features to place in an application, the host system including a processor system having at least one processor and a memory system;
in response, receiving at the host system from the user system, a selection of at least one feature to place in the application;
generating, by the processor system, the application based on the selection of the at least one feature that was received; and
sending the application, from the host system to the user system.
